(19) United States
(12) Patent Application Publication
(10) Pub. No.: US 2003/0207133 A1
(43) Pub. Date: Nov. 6, 2003

(54) Chromium (VI)-free conversion layer and method for producing it

(76) Inventors: Patricia Preikschat, Trebur (DE); Rolf Jansen, Trebur (DE); Peter Hulser, Trebur (DE)

Correspondence Address: PEARNE & GORDON LLP, 526 SUPERIOR AVENUE EAST, SUITE 1200, CLEVELAND, OH, 44114-1484, US

(21) Appl. No.: 09/904,993

(22) Filed: Jul. 13, 2001

Related U.S. Application Data
(63) Continuation of application No. 09/171,558, filed on Mar. 29, 1999, now Pat. No. 6,287,704.
Application No. 09/171,558 is a 371 of international application No. PCT/DE97/00800, filed on Apr. 18, 1997.

(30) Foreign Application Priority Data
Apr. 19, 1996 (DE) 196 15 664.5

(51) Int. Cl. B32B 15/04

(52) U.S. Cl. 428/472

(57) ABSTRACT

A chromium(VI)-free, chromium(III)-containing and substantially coherent conversion layer on zinc or zinc alloys presenting, even in the absence of further components such as silicate, cerium, aluminum and borate, a corrosion protection of approx. 100 to 1000 h in the salt spray test according to DIN 50021 SS or ASTM B 117-73 until first attack according to DIN 50961 Chapter 10; being clear, transparent and substantially colorless and presenting multi-colored iridescence; having a layer thickness of approx. 100 nm to 1000 nm; and being hard, adhering well and being resistant to wiping.

The present invention relates to chromium(VI)-free, chromium(III)-containing, substantially coherent conversion layers according to claim 1, a method for producing them according to claim 7, a concentrate according to claim 10, a passivation bath according to claim 14, a passivating method according to claim 20, a passive layer according to claim 24, and a conversion layer according to claim 28.

Metallic materials, in particular iron and steel, are plated with zinc or cadmium in order to protect them from corrosive environmental influences. The corrosion protection of zinc resides in the fact that it is even less precious than the base metal and therefore at first exclusively draws the corrosive attack; it acts as a sacrificial layer. The base metal of the respective zinc-plated component remains unimpaired as long as it is continuously covered with zinc, and the mechanical functionality remains preserved over longer periods of time than in the case of parts not plated with zinc. Thicker zinc layers naturally afford higher corrosion protection than thin layers inasmuch as corrosive erosion of thicker layers simply takes more time.

The corrosive attack on the zinc layer, in turn, can be greatly delayed by application of a chromation, or chromate coating, whereby corrosion of the base metal is even further postponed than by mere zinc plating. A considerably better corrosion protection is afforded by the zinc/chromate layer system is than by a mere zinc layer of identical thickness. Moreover by means of chromation the optical deterioration of a component due to environmental influences is further postponed—the corrosion products of zinc, referred to as “white rust”, equally interfere with the optical appearance of a component.

The advantages of an applied chromation are so important that almost any galvanically zinc-plated surface is in addition chromate coated as well. The prior art knows four chromations named after their colorations, which are each applied by treating (immersion, spraying, rolling) a zinc-plated surface with the corresponding aqueous chromate coating solution. Moreover yellow and green chromations for aluminum are known which are produced analogously. In any case, these are variously thick layers of substantially amorphous zinc/chromium oxide (or aluminum/chromium oxide) with non-stoichiometric compositions, a certain water content, and inserted foreign ions. These are known and classified into method groups in accordance with German Industrial Standard (DIN) 50960, Part 1:

1) Colorless and Blue Chromations, Groups A and B

The blue chromate layer has a thickness of up to 80 nm, is weakly blue in its inherent color and presents a golden, reddish, bluish, greenish or yellow iridescent coloring Drought about by refraction of light in accordance with layer thicknesses. Very thin chromate layers lacking almost any inherent color are referred to as colorless chromations (Group A). The chromate coating solution may in either case consist of hexavalent as well as trivalent chromates and mixtures of both, moreover conducting salts and mineral acids. There are fluoride-containing and fluoride-free variants. Application of the chromate coating solutions is performed at room temperature. The corrosion protection of unmarred blue chromations amounts to 10-40 h in the salt spray cabinet according to DIN 50021 SS until the first appearance of corrosion products. The minimum requirement for Method Groups A and B according to DIN 50961 Chapter 10 Table 3 is 8 h for drumware and 16 h for shelfware.

2) Yellow Chromations, Group C

The yellow chromate layer has a thickness of approx. 0.25-1 μm, a golden yellow coloring, and frequently a strongly red-green iridescent coloring. The chromate coating solution substantially consists of hexavalent chromate, conducting salts and mineral acids dissolved in water. The yellow coloring is caused by the significant proportion (80-220 mg/m²) of hexavalent chromium which is inserted besides the trivalent chromium produced by reduction in the course of the layer formation reaction. Application of the chromate coating solutions is performed at room temperature. The corrosion protection of unmarred yellow chromations amounts to 100-200 h in the salt spray cabinet according to DIN 50021 SS until the first appearance of corrosion products. The minimum requirement for Method Group C according to DIN 50961 Chapter 10 Table 3 amounts to 72 h for drumware and 96 h for shelfware.

3) Olive Chromations, Group D

The typical olive chromate layer has a thickness of up to 1.5 μm and is opaquely olive green to olive brown. The chromate coating solution substantially consists of hexavalent chromate, conducting salts and mineral acids dissolved in water, in particular phosphates or phosphoric acid, and may also contain formates. Into the layer considerable amounts of chromium(VI) (300-400 mg/m²) are inserted. Application of the chromate coating solutions is performed at room temperature. The corrosion protection of unmarred olive chromations amounts to 200-400 h in the salt spray cabinet according to DIN 50021 SS until the first appearance of corrosion products. The minimum requirement for Method Group D according to DIN 50961 Chapter 10 Table 3 is 72 h for drumware and 120 h for shelfware.

4) Black Chromations, Group F

The black chromate layer is fundamentally a yellow or olive chromation having colloidal silver inserted as a pigment. The chromate coating solutions have about the same composition as yellow or olive chromations and additionally contain silver Ions. With a suitable composition of the chromate coating solution on zinc alloy layers such as Zn/Fe, Zn/Ni or Zn/Co, iron, nickel or cobalt oxide will be incorporated into the chromate layer as a black pigment so that silver is not required in these cases. Into the chromate layers considerable amounts of chromium(VI) are inserted, namely between 80 and 400 mg/m² depending on whether the basis is a yellow or olive chromation. Application of the chromate coating solutions is performed at room temperature. The corrosion protection of unmarred black chromations on zinc amounts to 50-150 h in the salt spray cabinet according to DIN 50021 SS until the first appearance of corrosion products. The minimum requirement for Method Group E according to DIN 50961 Chapter 10 Table 3 is 24 h for drumware and 48 h for shelfware. Black chromations on zinc alloys are considerably above the specified values.

5) Green Chromations for Aluminum, Group E

The green chromation on aluminum (known under the name of aluminum green) is of a matt green and not iridescent. The chromate coating solution substantially consists of hexavalent chromate, conducting salts and mineral acids dissolved in water as well as particularly phosphates and silicofluorides. Contrary to a prevailing opinion the formed chromate/phosphate layer is, as evidenced by iodised starch tests, not always 100% chromium(VI)-free. The production of aluminum green in chromate coating solutions exclusively on the basis of chromium(III) is not known.

In accordance with the prior art, thick chromate layers affording high corrosion protection >100 h in the salt spray cabinet according to DIN 50021 SS or ASTM B 117-73 until the appearance of first corrosion products according to DIN 50961 (June 1987) Chapter 10, in particular Chapter 10.2.1.2, in the absence of sealing or any other particular aftertreatment (DIN 50961, Chapter 9) may only be produced by treatment with dissolved, markedly toxic chromium(VI) compounds. Accordingly the chromate layers having the named requirements to corrosion protection still retain these markedly toxic and carcinogenic chromium(VI) compounds, which are, moreover, not entirely immobilised in the layer. Chromate coating with chromium(VI) compounds is problematic with respect to workplace safety. Use of zinc-plated chromations produced with chromium(VI) compounds, such as the widespread yellow chromations e.g. on screws, constitutes a potential hazard to the population and increases the general cancer risk. U.S. Pat. No. 4,384,902, in particular with Examples 1, 2, 4 and 5, describes conversion layers which satisfy the requirements in the salt spray test. In all of the cases, these are cerium-containing layers presenting a yellowish coloration which is accentuated by the cerium(IV) ion. The examples only contain cerium(III), and hydrogen peroxide as an oxidant, in the bath solution. In the description it is set forth that hydrogen peroxide in the acidic medium does not represent an oxidant for Ce(III), however during deposition the pH value nevertheless rises so high at the surface that a sufficient amount of Ce(IV) may be generated. The yellowish coloration achieved by this bath composition indeed appears to indicate that an oxidation has taken place—however, only an oxidation from Ce(III) to Ce(IV). Tetravalent cerium is an even more powerful oxidant than hexavalent chromium, for which reason Ce(IV) will produce from Cr(III) the Cr(VI) which is to be avoided. Cr(VI) has a very strong yellow coloration and is known as an anticorrosion agent. The layer described in U.S. Pat. No. 4,384,902 is thus not free of hexavalent chromium.

The layer according to the invention is, however, produced in the absence of any oxidant and consequently free of hexavalent chromium. This can in particular be seen from the fact that the layer according to the invention is not yellow.

Even where the yellow coloration and the enhanced corrosion protection should be brought about by nothing but Ce(IV), the layer according to the invention affords the desired corrosion protection even without this very costly and rare addition.

U.S. Pat. No. 4,359,348 also describes conversion layers which satisfy the above mentioned requirements in the salt spray test. These, too, in all cases are cerium-containing layers which present the yellowish coloration accentuated by the cerium(IV) ion. This document thus does not exceed U.S. Pat. No. 4,384,902.

It is therefore an object of the present invention to furnish a chromium(VI)-free, thick conversion layer having a high chromium content on zinc or zinc alloys.

With respect to a layer this object is attained by the features of claims 1, 24 and 28, with respect to method technology by the features of claims 7 and 20, and with respect to a composition for carrying out the method of the invention by the features of claims 10 and 14.

For the purposes of the present inventions the applicant coined the term “chromitation” in order to clearly distinguish the present invention from the chromations which are customary in the prior art, and in order to make clear that neither the obtained conversion layer nor the compositions (concentrates/passivation baths) whereby the coatings according to the invention are produced contain the toxic chromium(VI), whereas the obtained corrosion protection nevertheless is superior to that of yellow chromation.

EP 00 34 040 A1 does describe a multiplicity of layers, of the larger group of which (produced under the standard conditions set forth by Barnes/Ward) the color is not specified, however referred to as clear. Two Examples, namely Nos. 16 and 17, describe a greenish borate-containing layer described as cloudy-dull to non-transparent.

Example 14 describes a layer affording a corrosion protection of only 4 hours.

The subclaims represent preferred embodiments of the present invention.

Concerning the features of claim 2, the following should be noted:

In glow-discharge spectrometry several elements could not be detected while others could not be calibrated. Therefore the chromium/(chromium+zinc) phases were compared to each other. The chromium index is the average chromium content in % in the layer >1% Cr multiplied by the layer thickness. The chromium index is proportional to the chromium quantity on the surface (mg/m²).

Further advantages and features of the present invention result from the description of embodiments and from theoretical reflections which are not binding on the one hand and were, on the other hand, carried out by the inventors while having knowledge of the present invention, and by referring to the drawing, wherein:

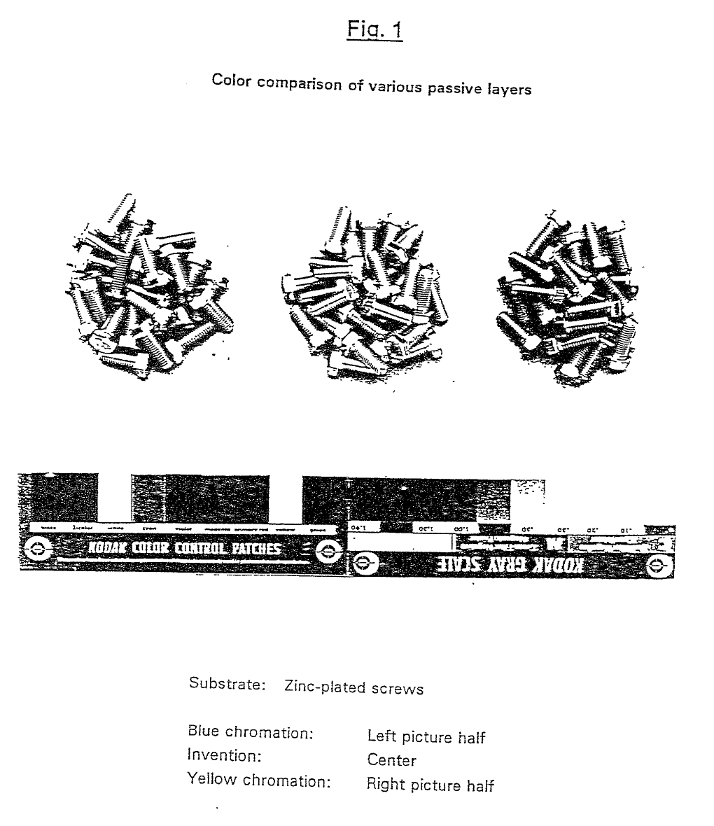

FIG. 1 shows a comparison of the present invention with blue and yellow chromations;

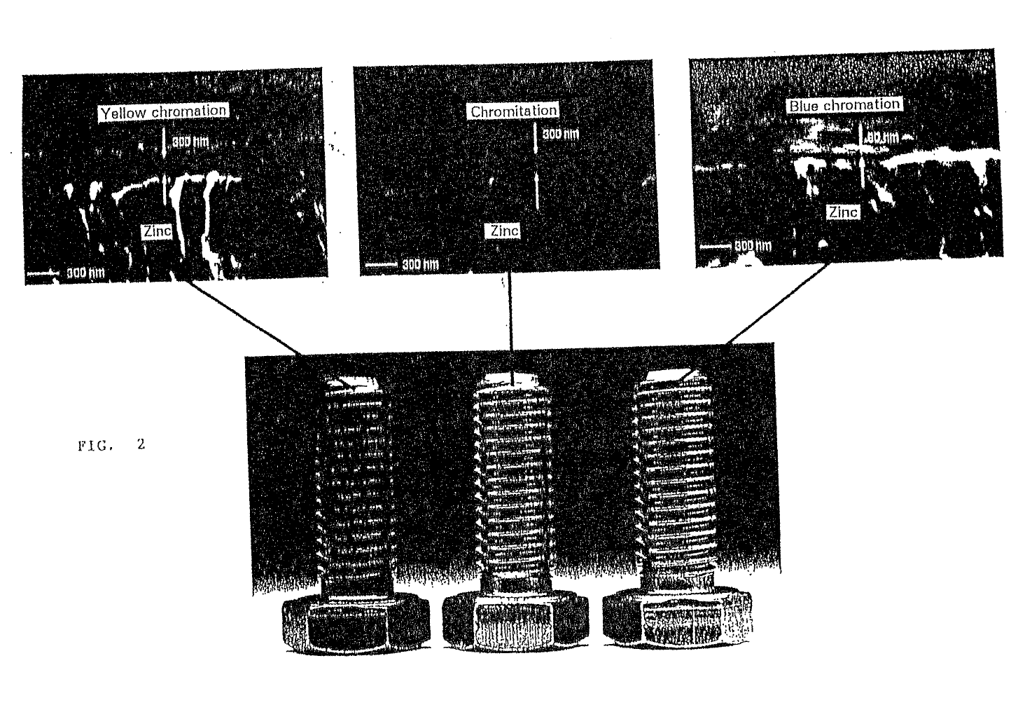

FIG. 2 is a scanning electron microscope image (40,000×) showing a comparison of the present invention (“chromitation”) with blue and yellow chromations;

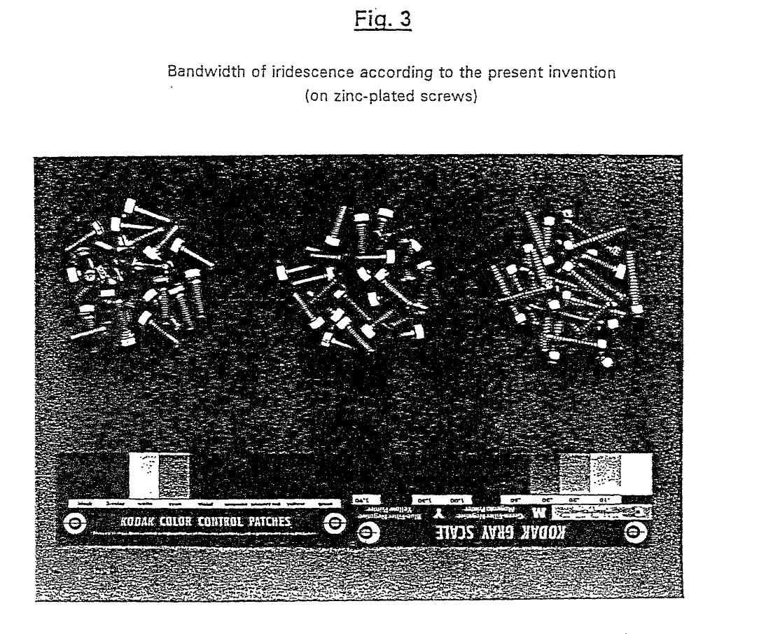

FIG. 3 is a color photo showing the band width of the iridescent coloring in accordance with the present invention on zinc surfaces;

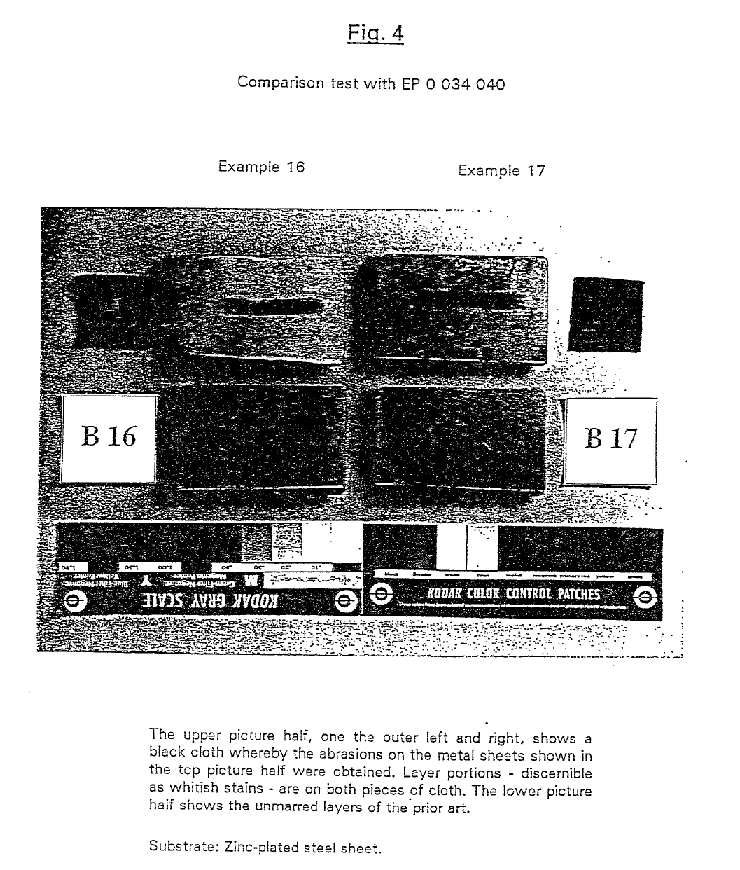

FIG. 4 shows coatings of the prior art in accordance with EP 0 034 040;

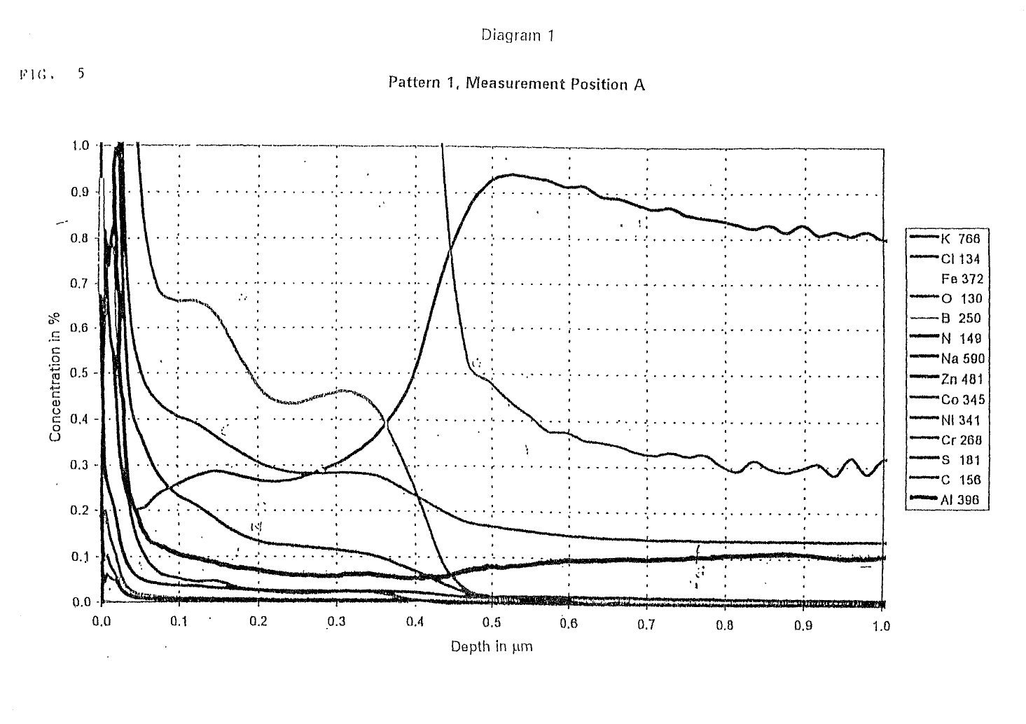

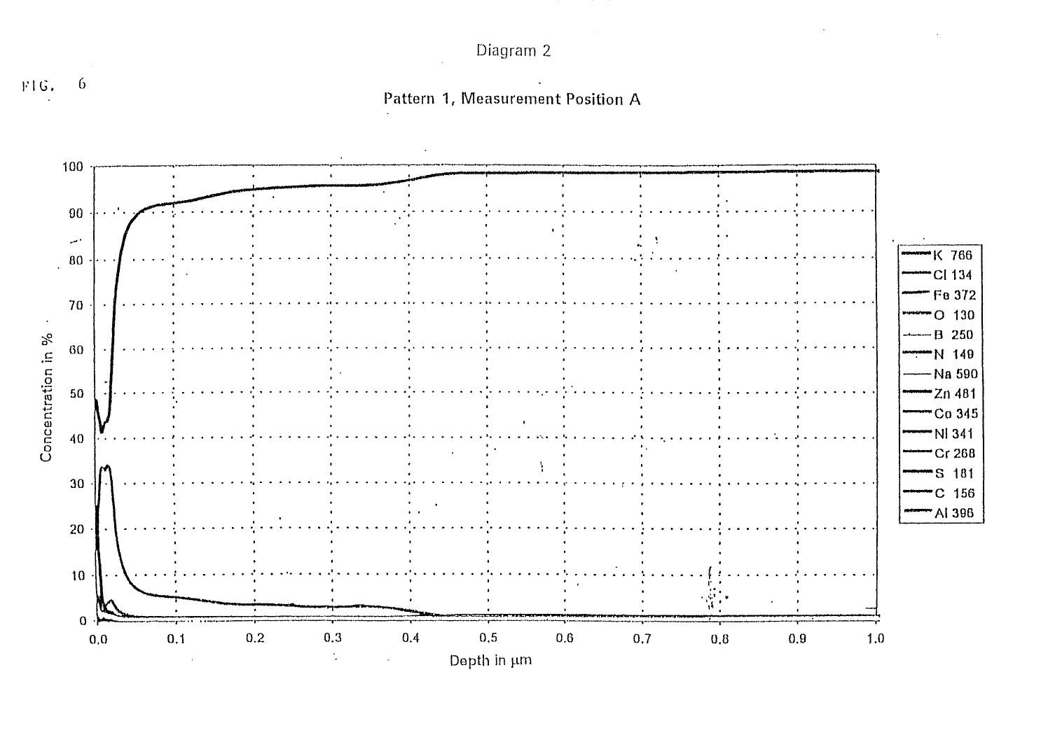

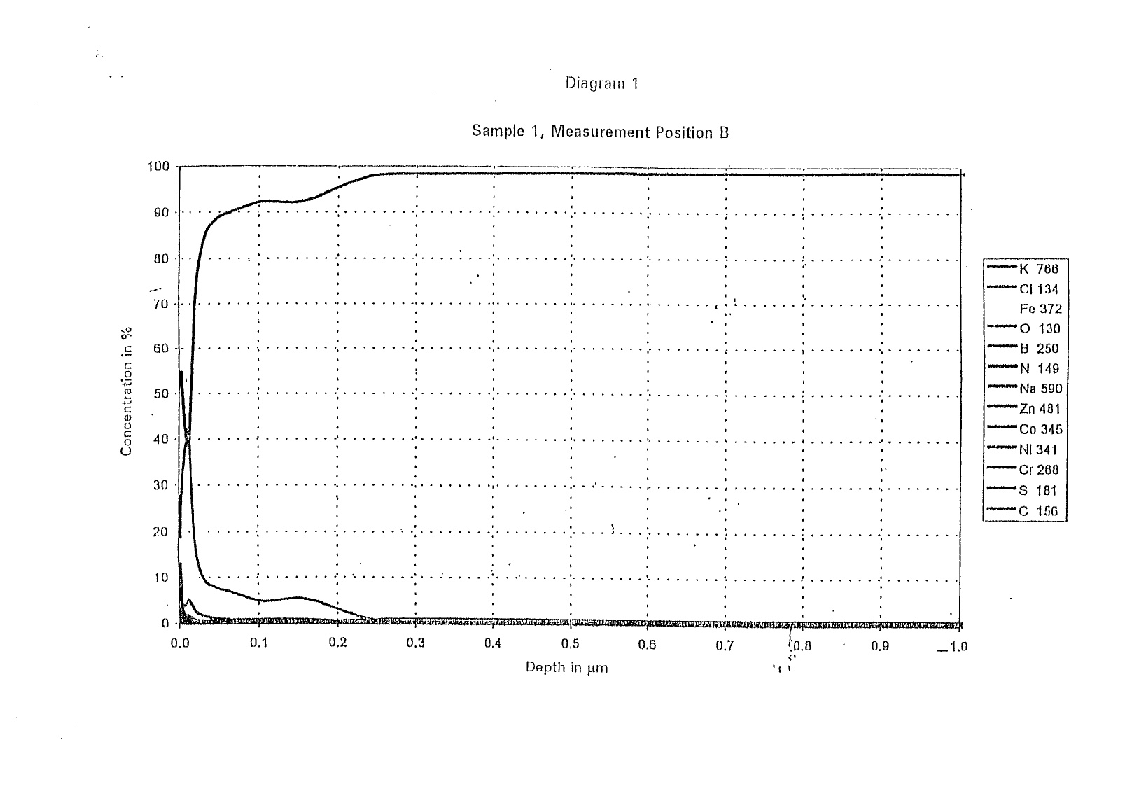

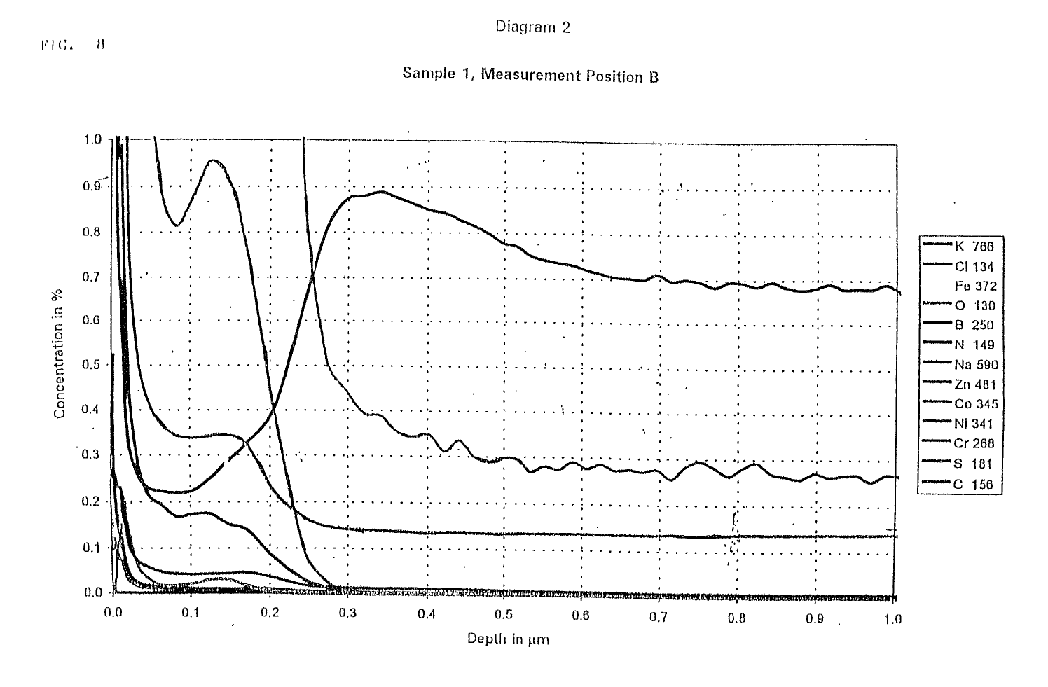

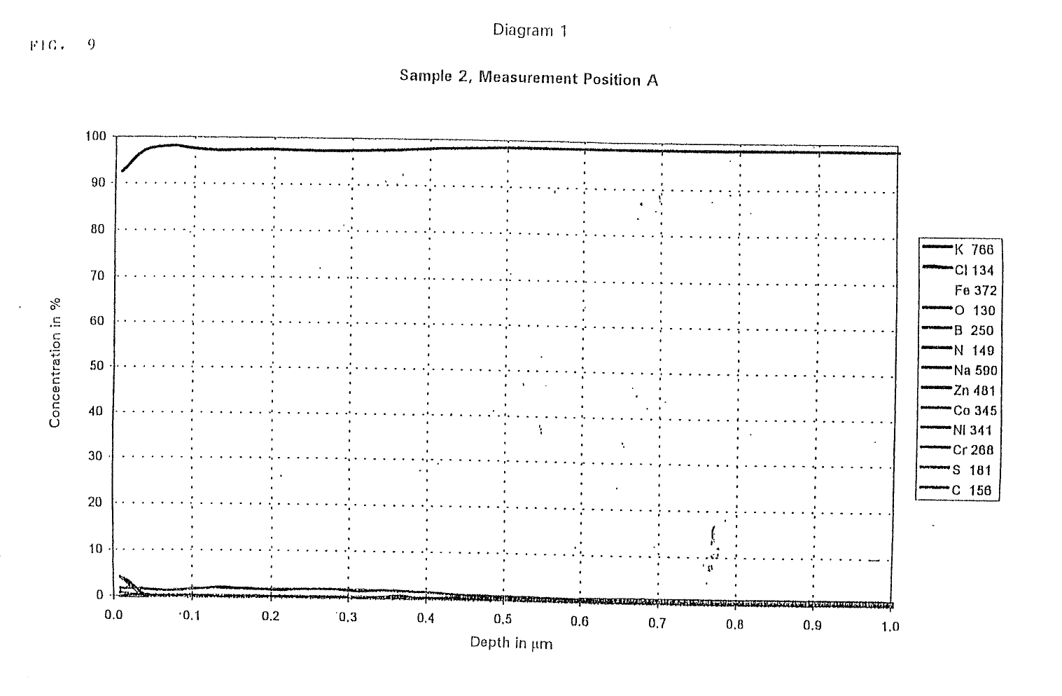

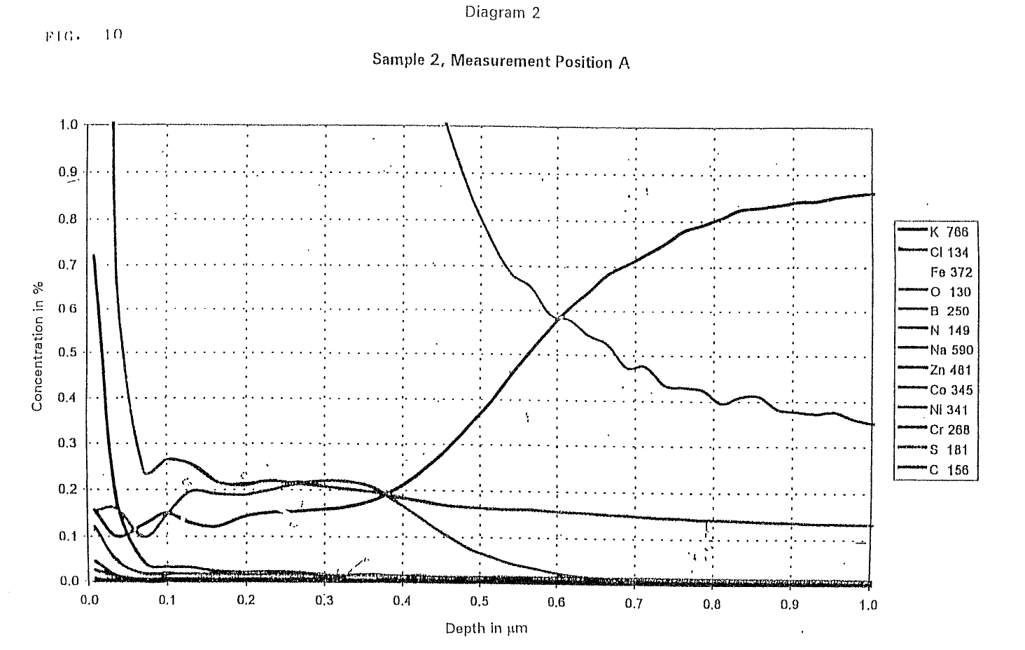

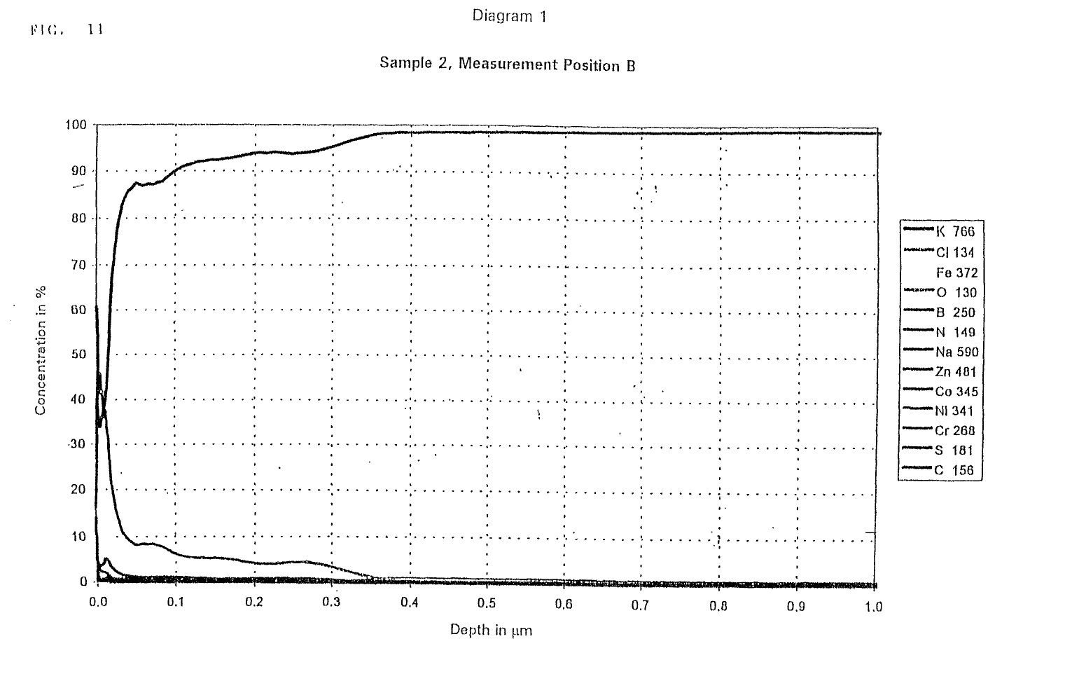

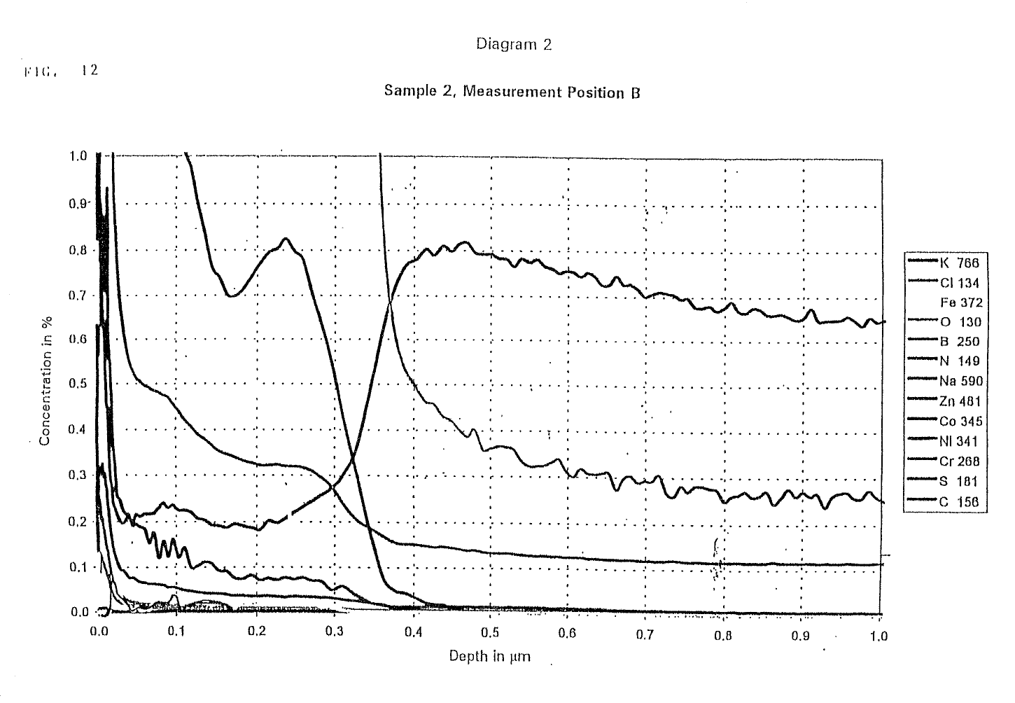

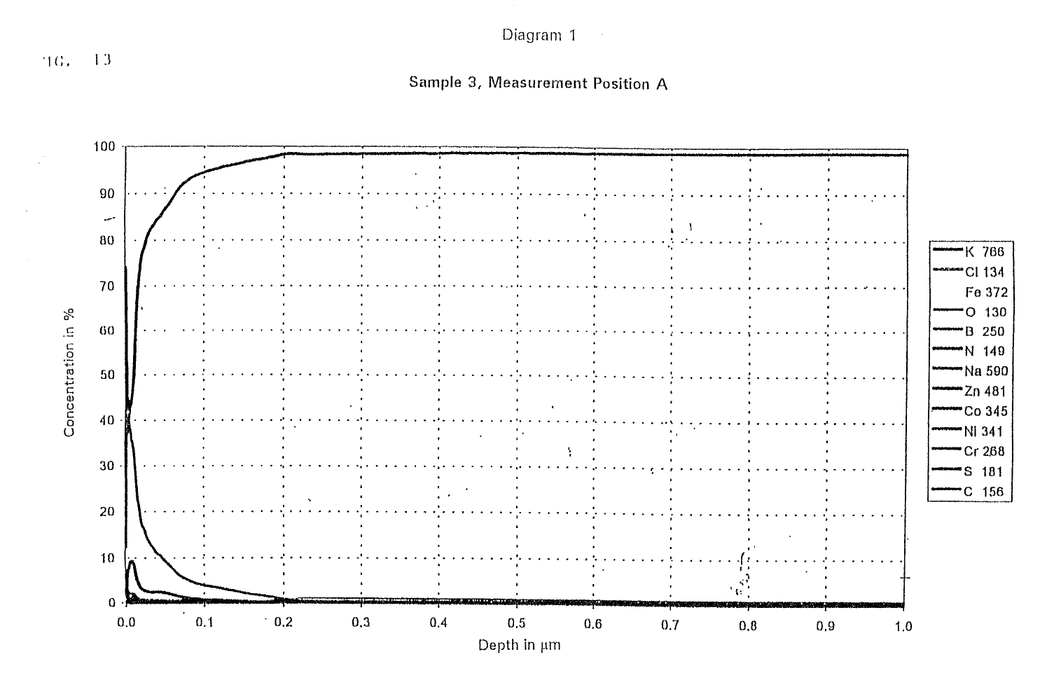

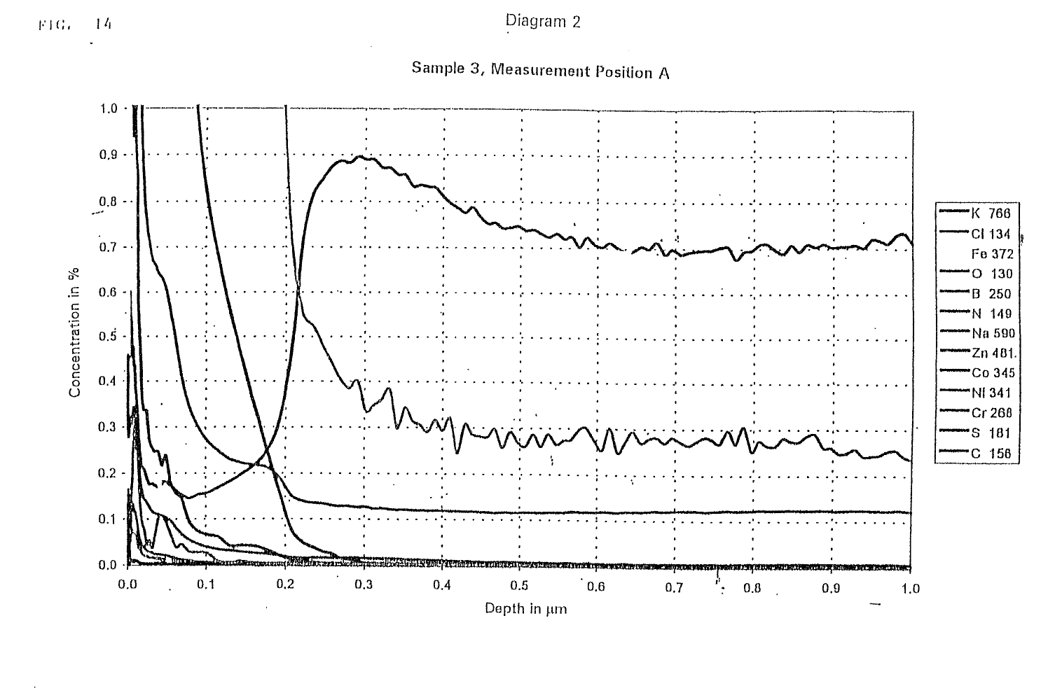

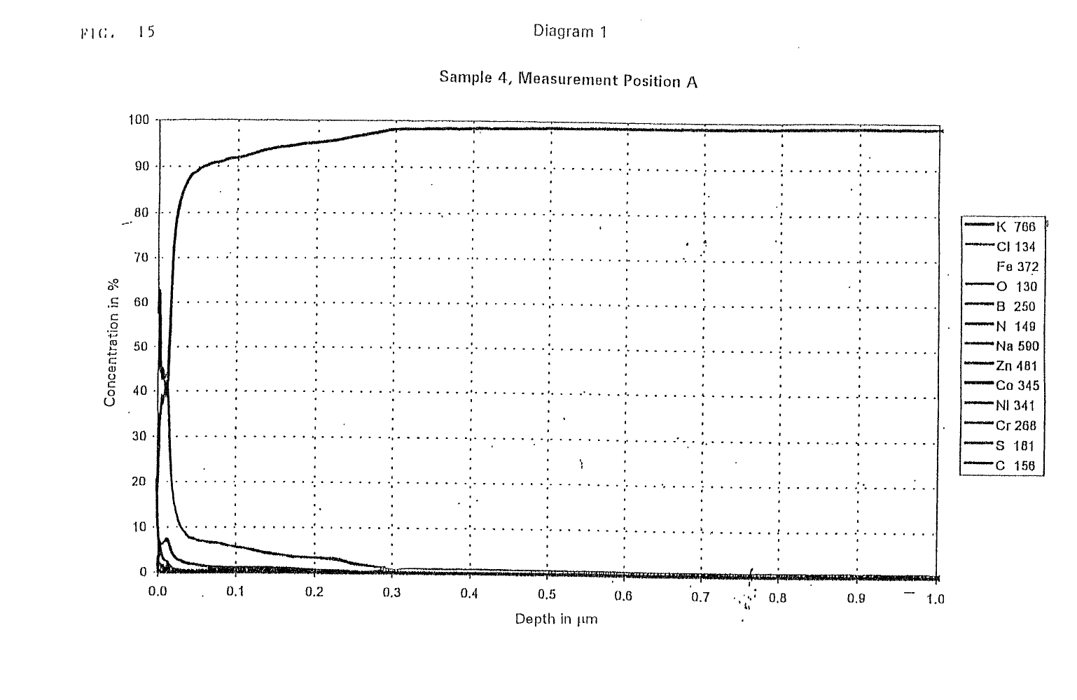

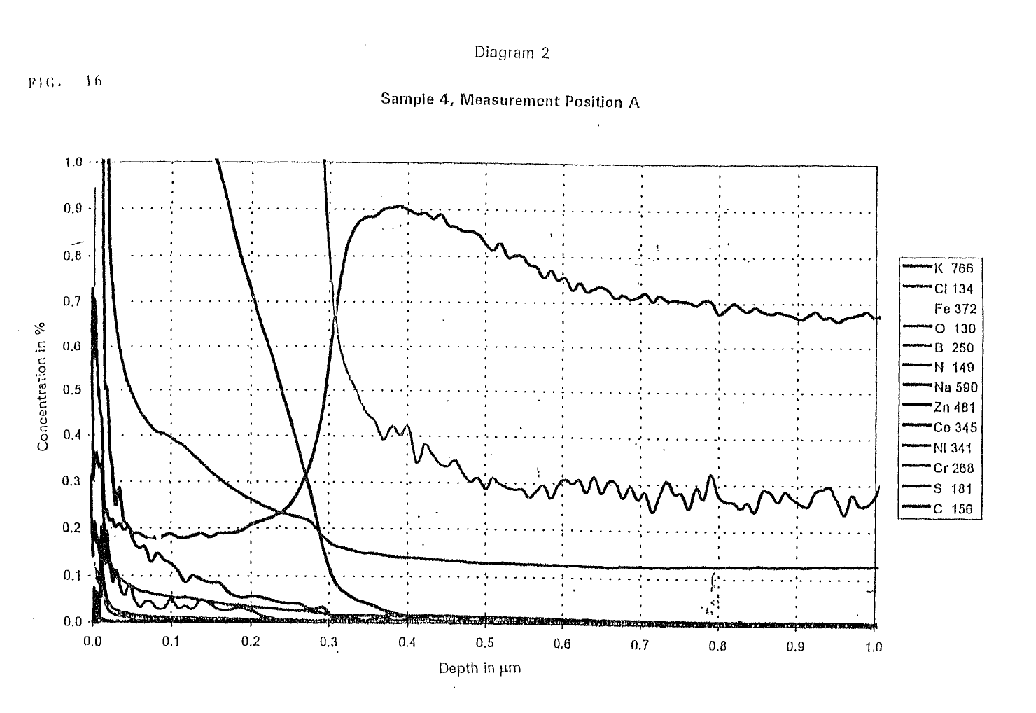

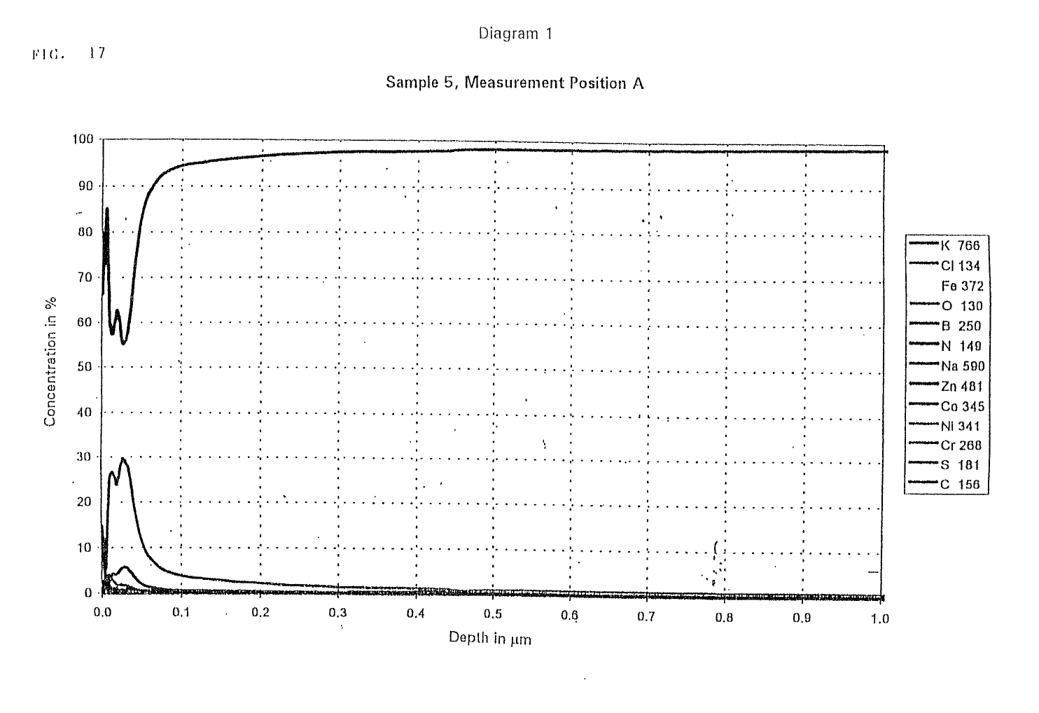

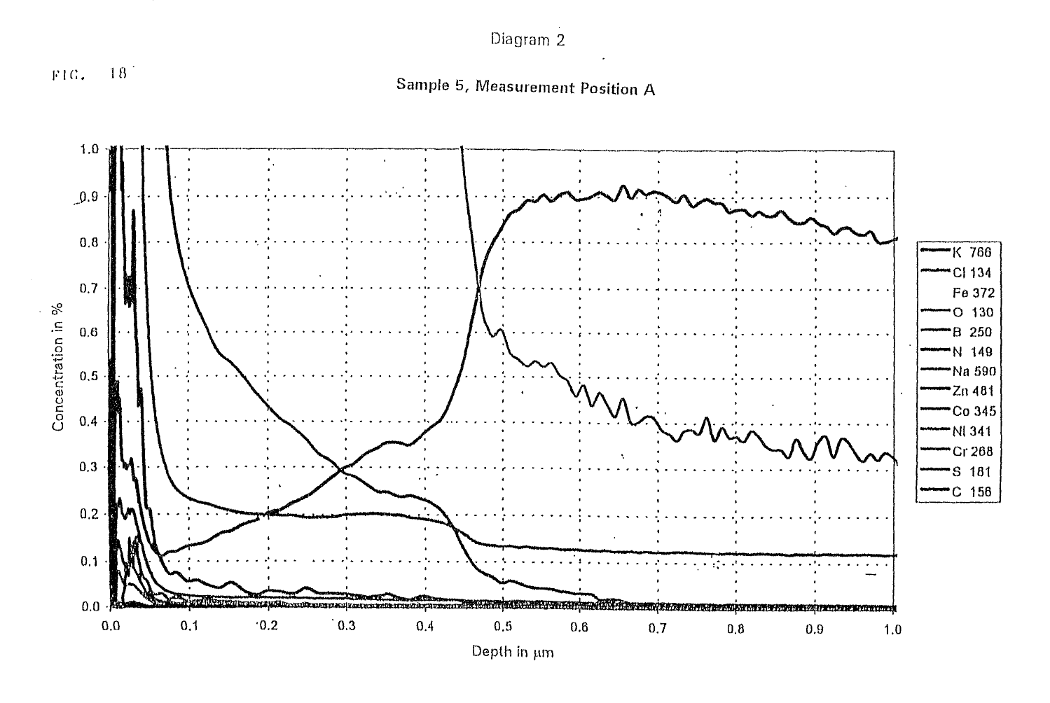

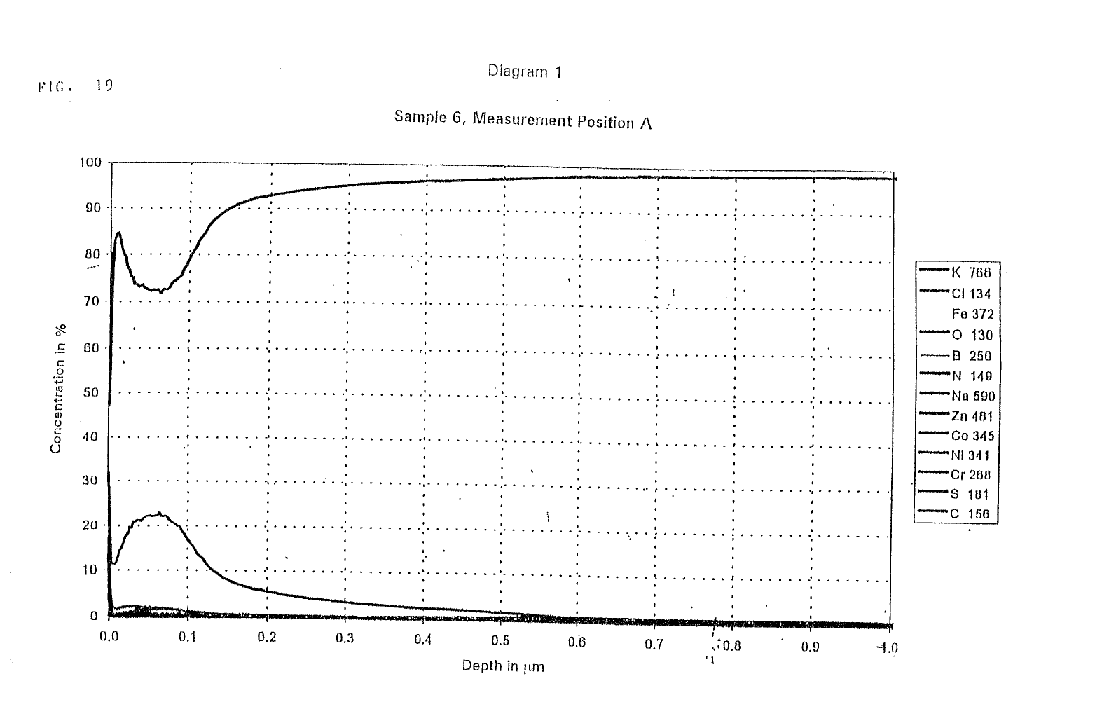

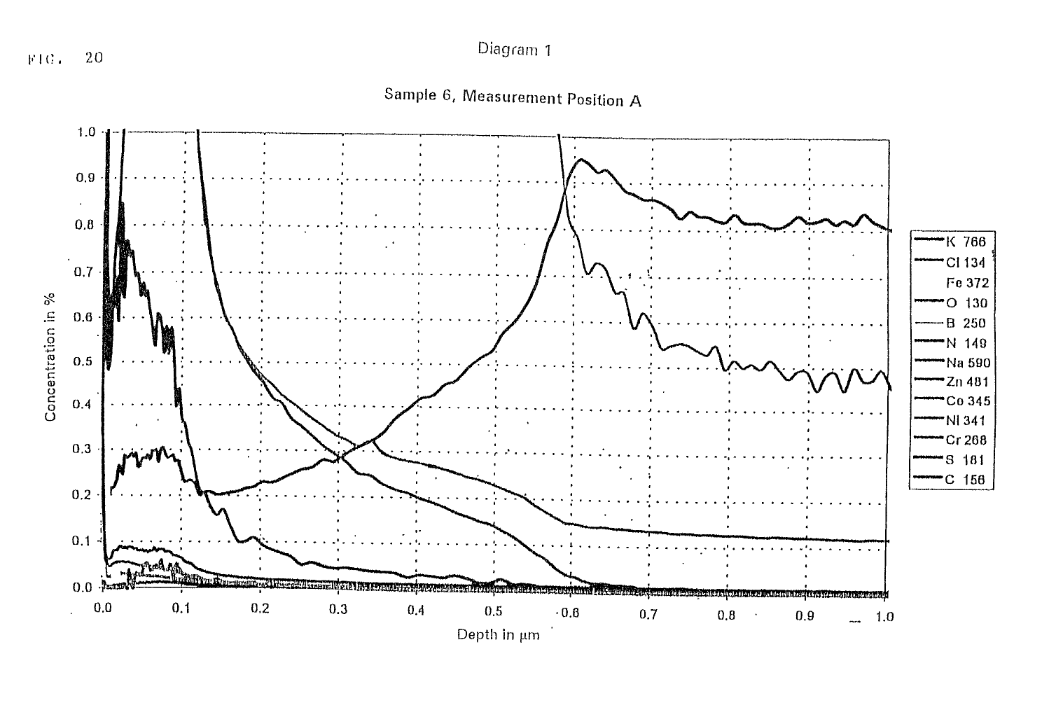

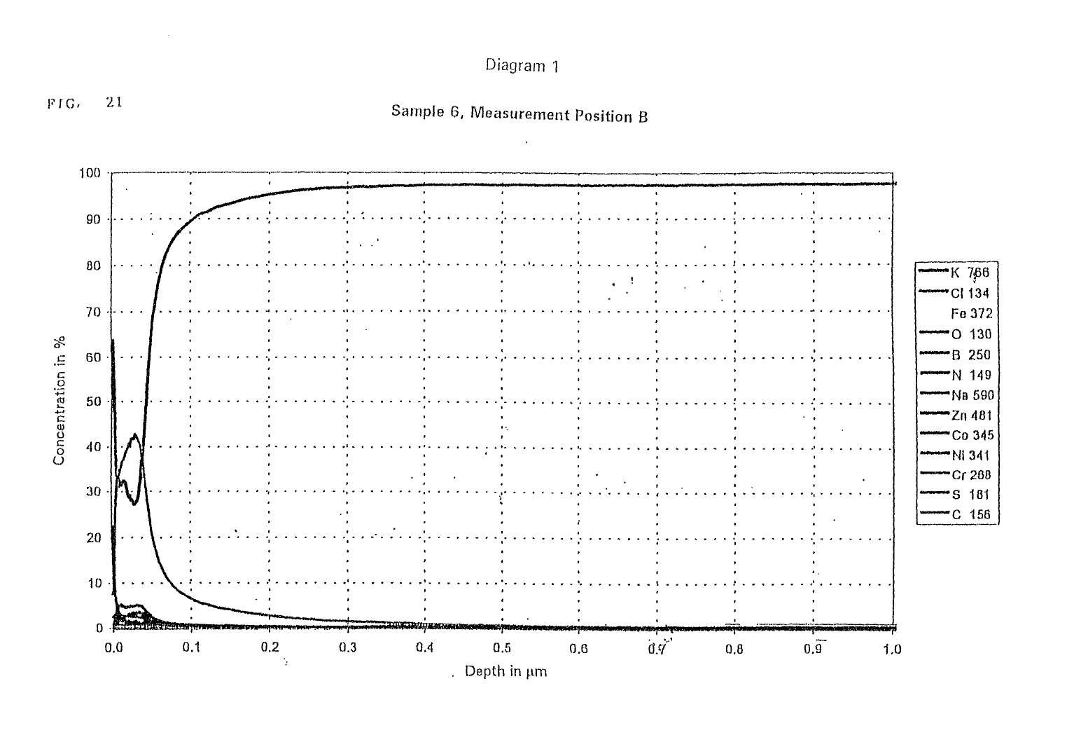

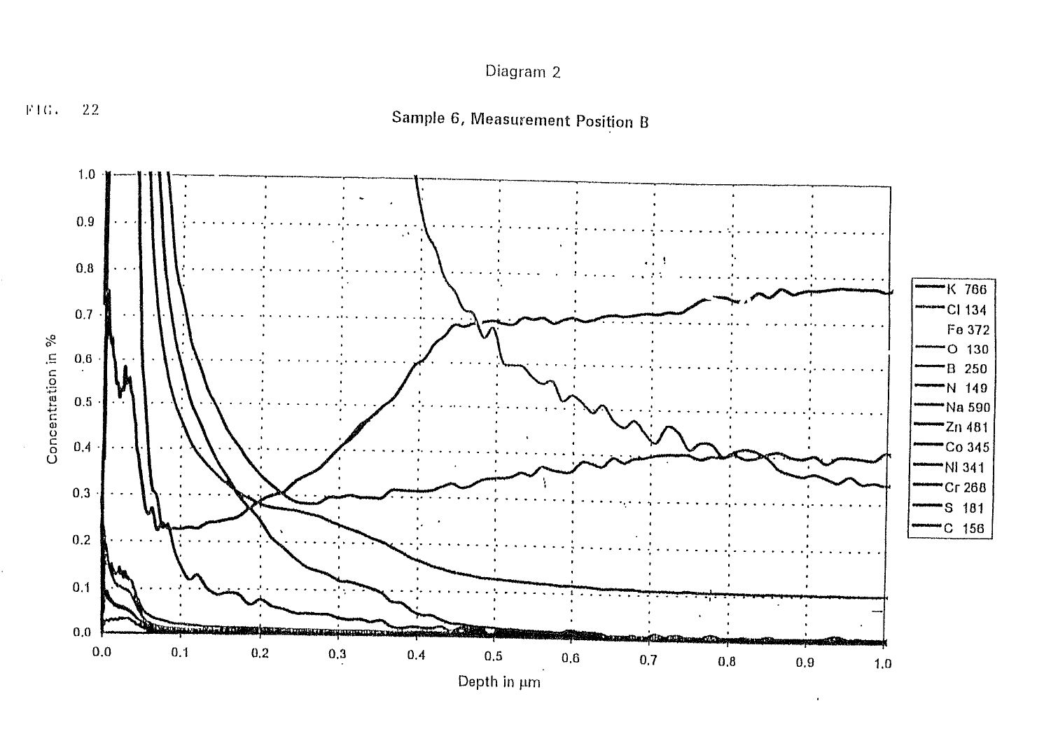

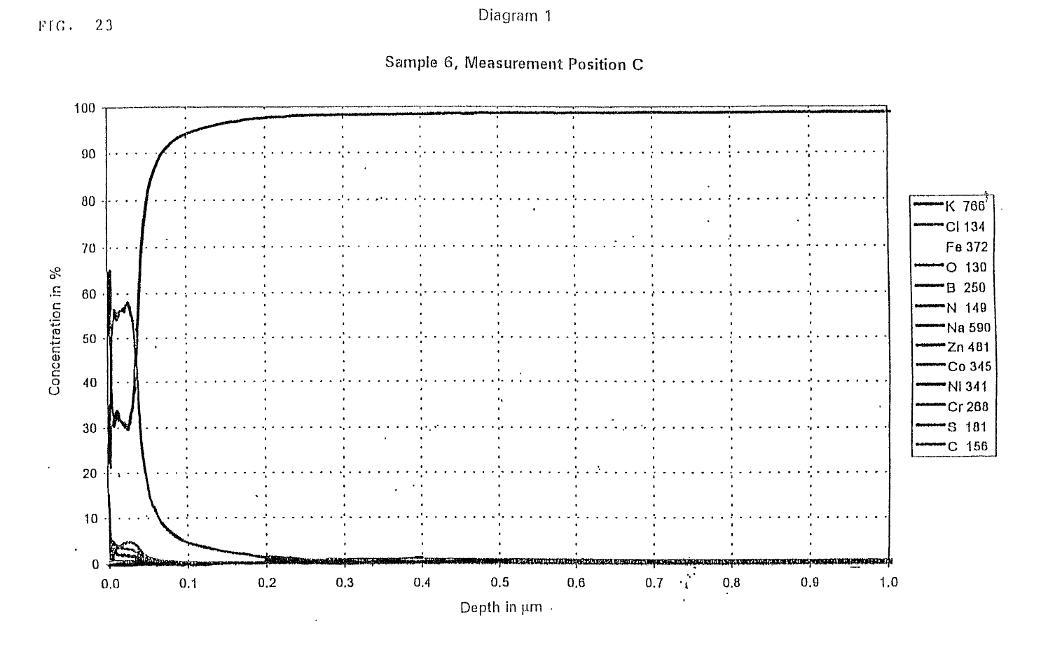

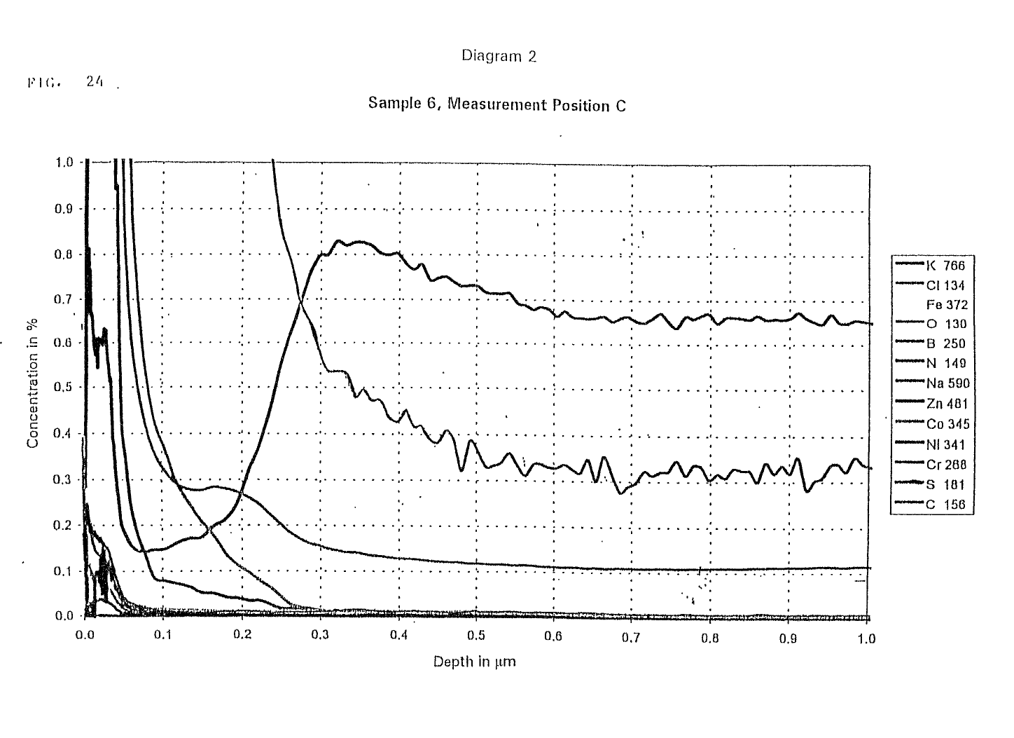

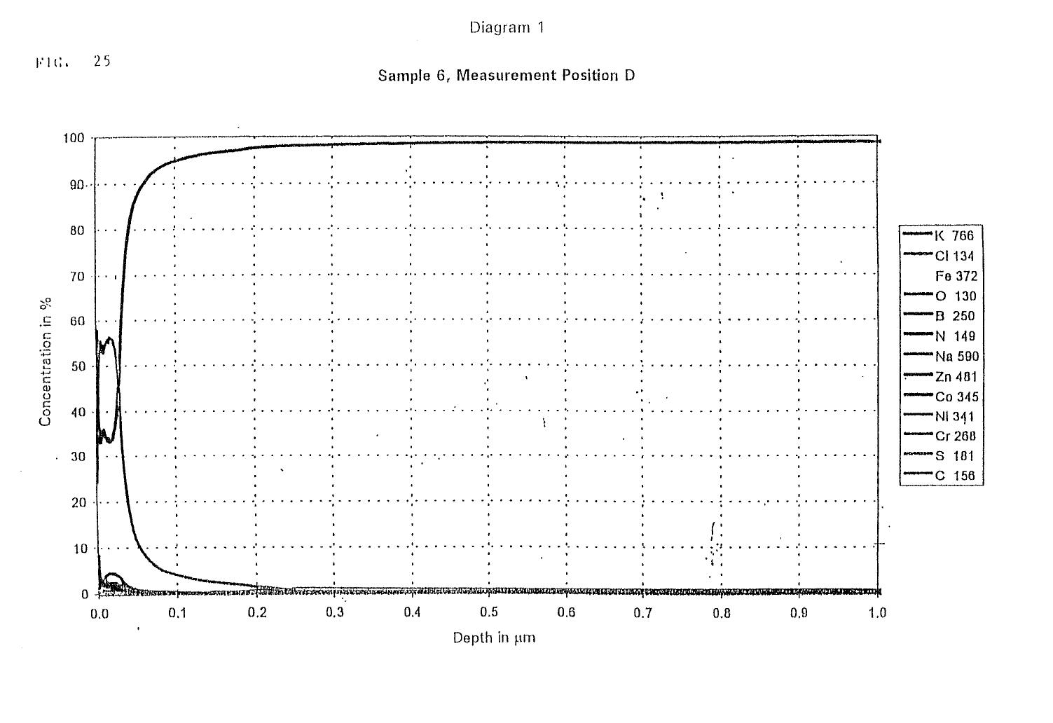

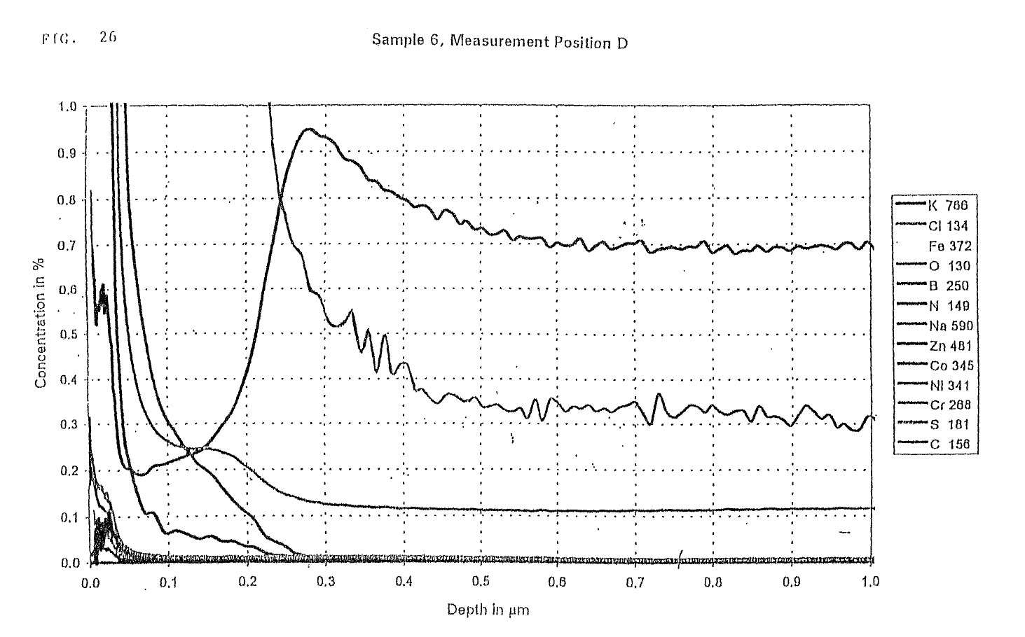

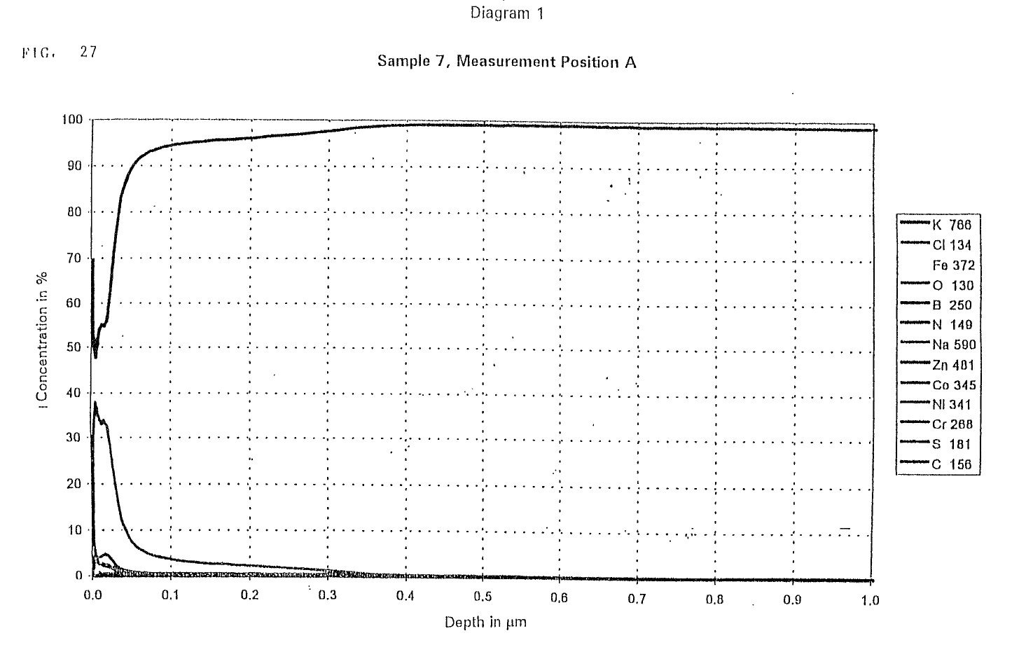

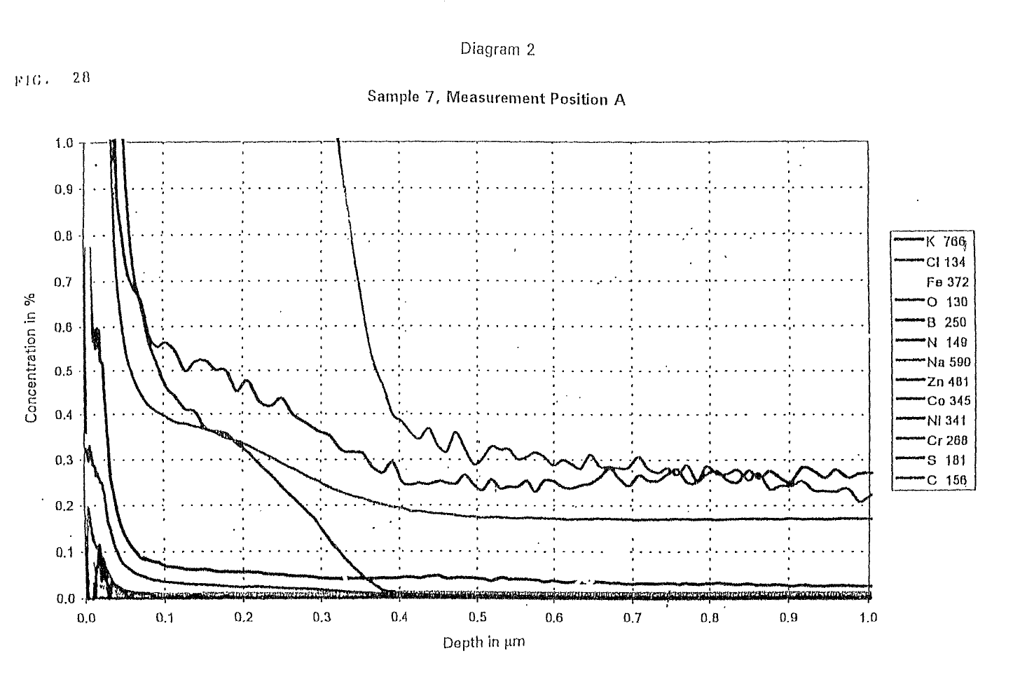

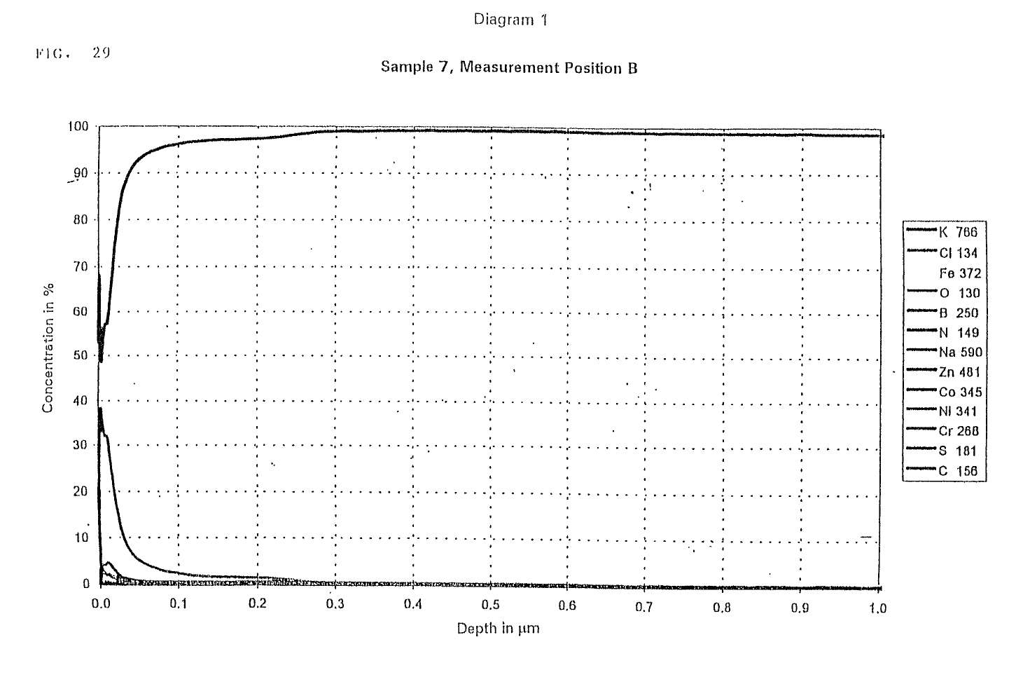

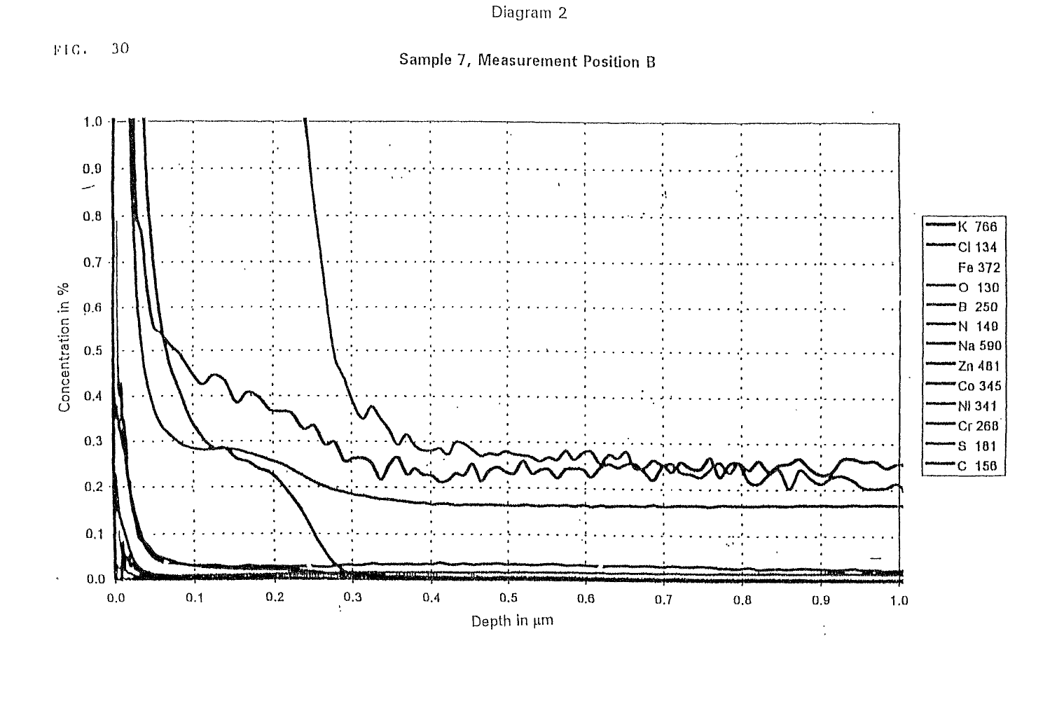

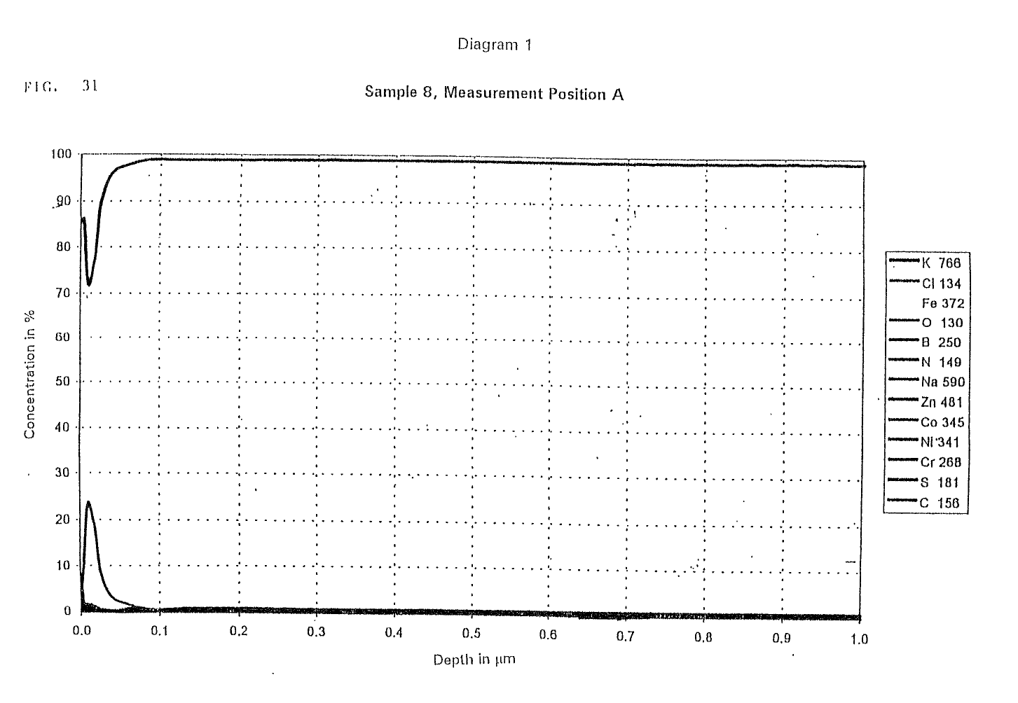

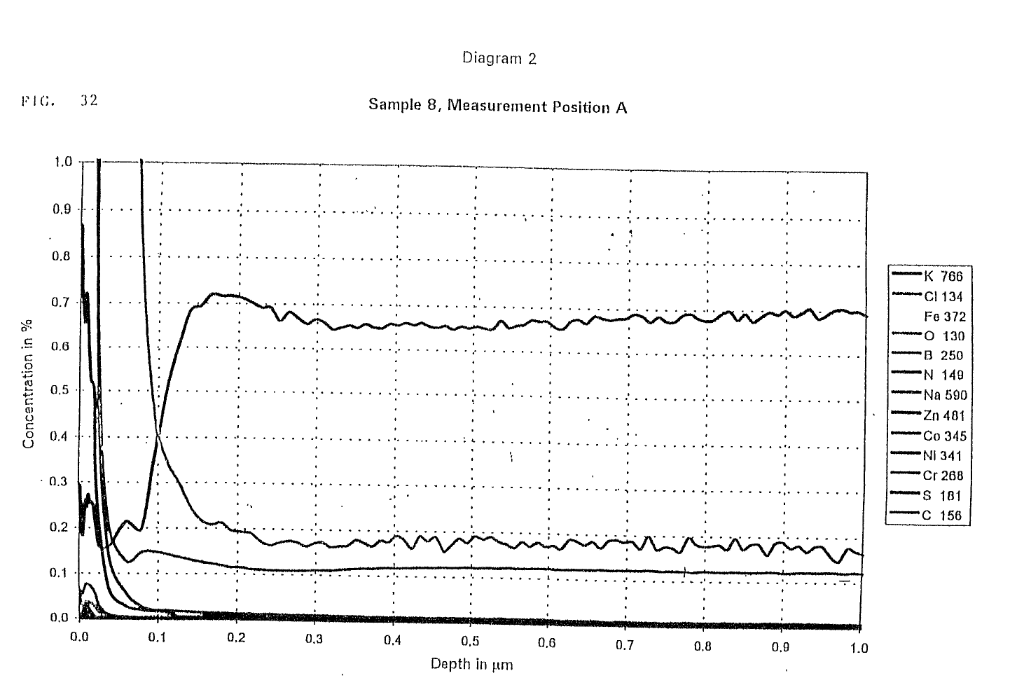

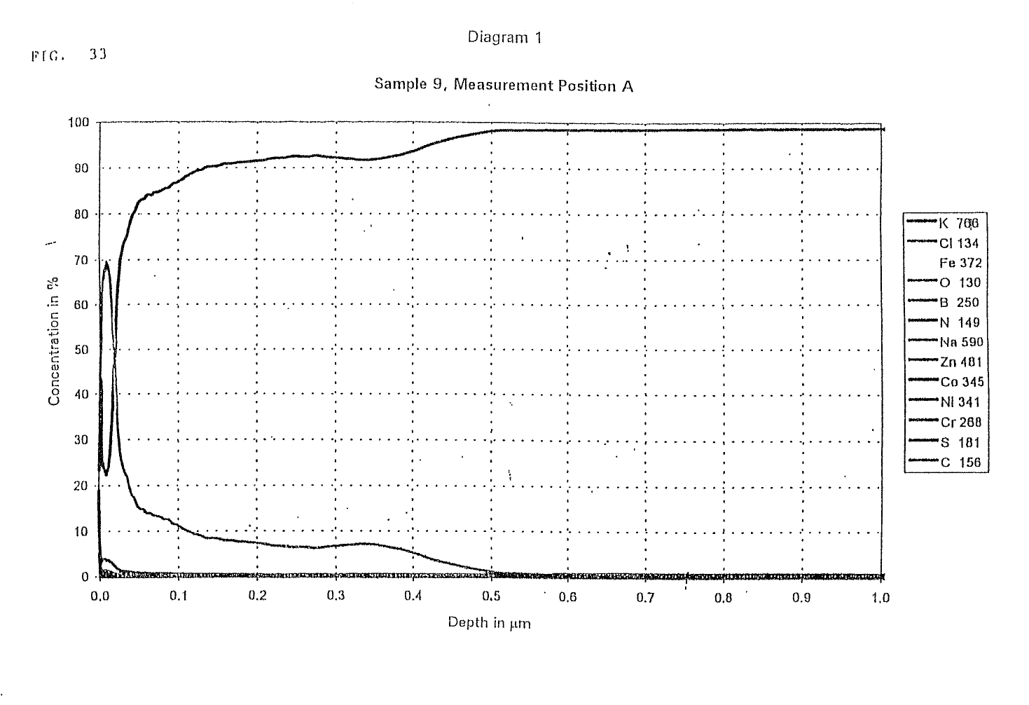

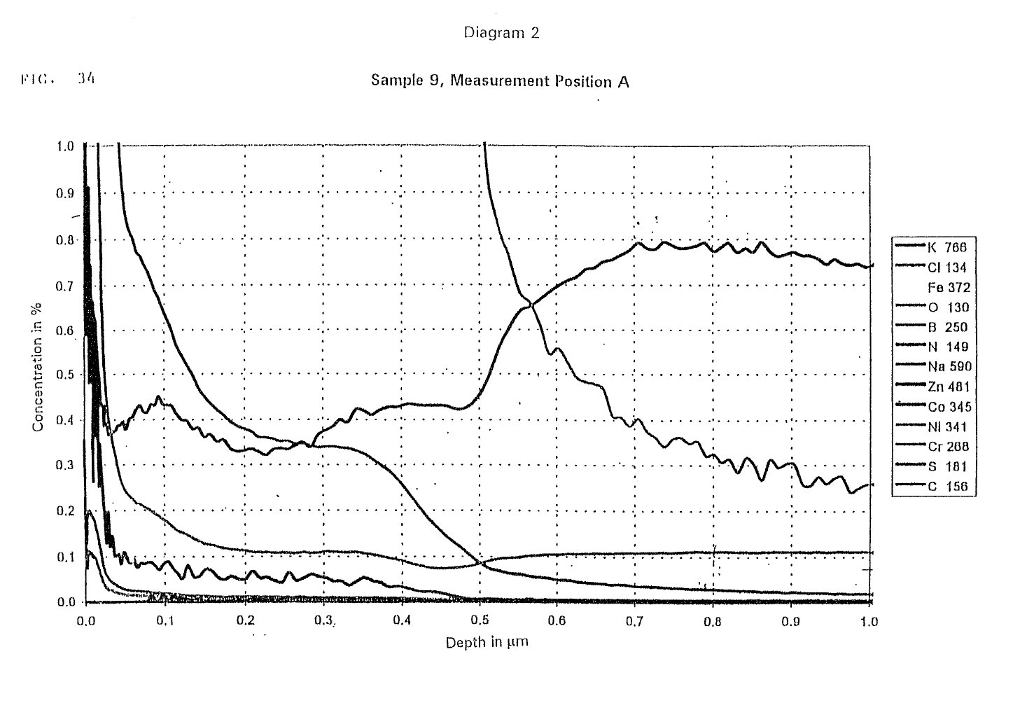

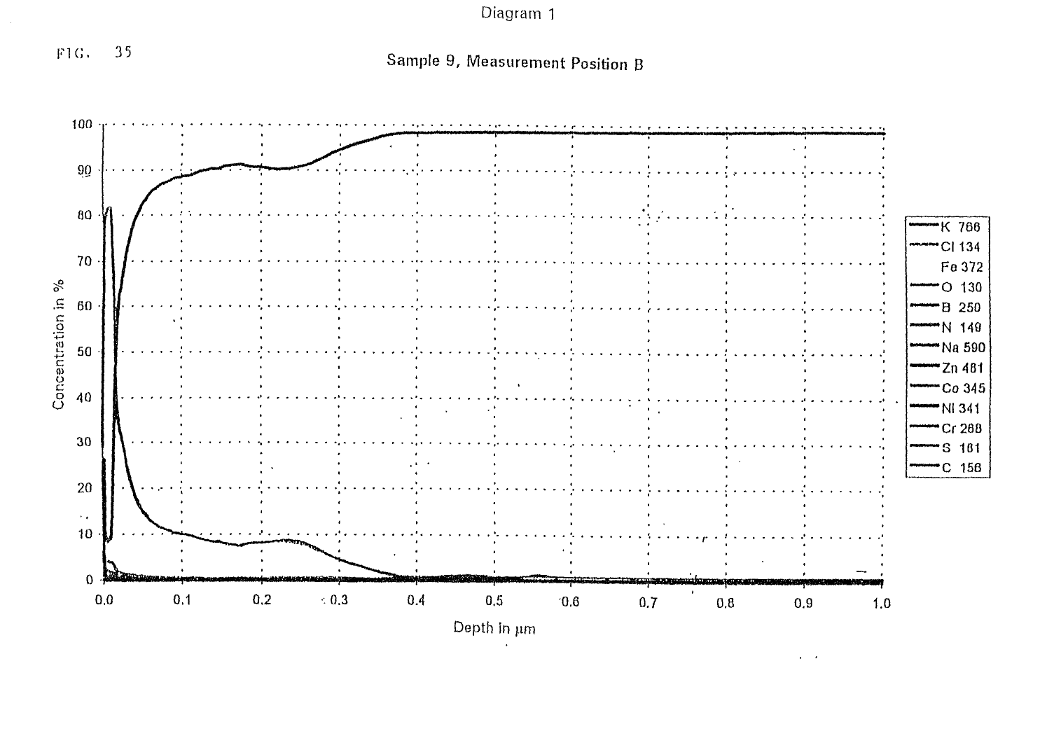

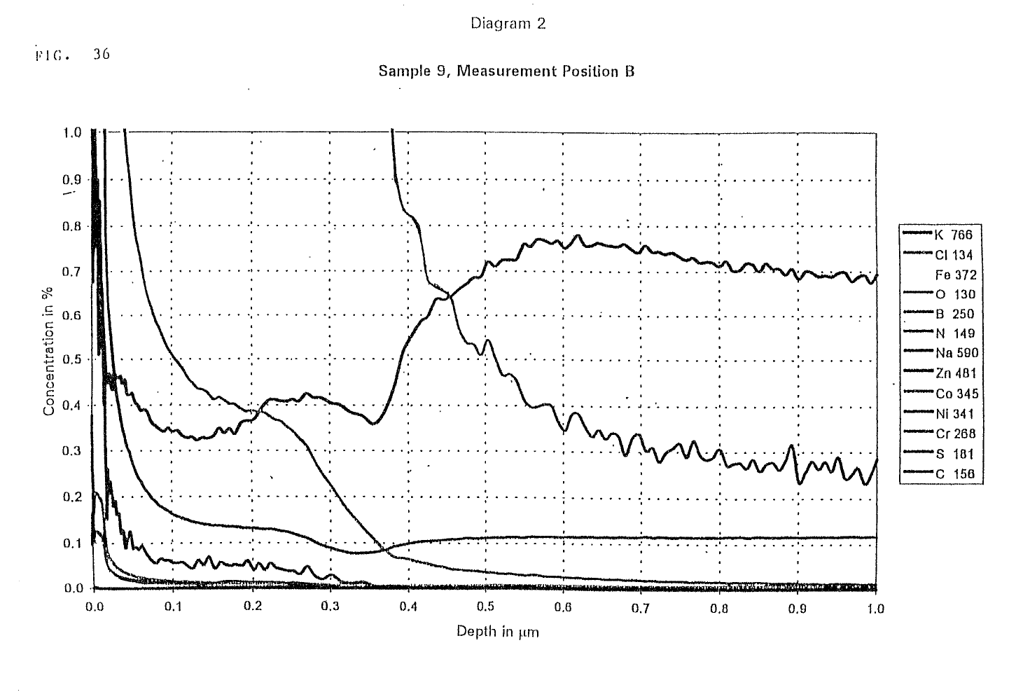

FIGS. 5 to 36 show depth profile analyses of layers according to the invention and layers resulting from the conventional blue and yellow chromations, wherein the depth profile analyses were measured by glow-discharge spectrometry (spectrometer: JY5000RF); and

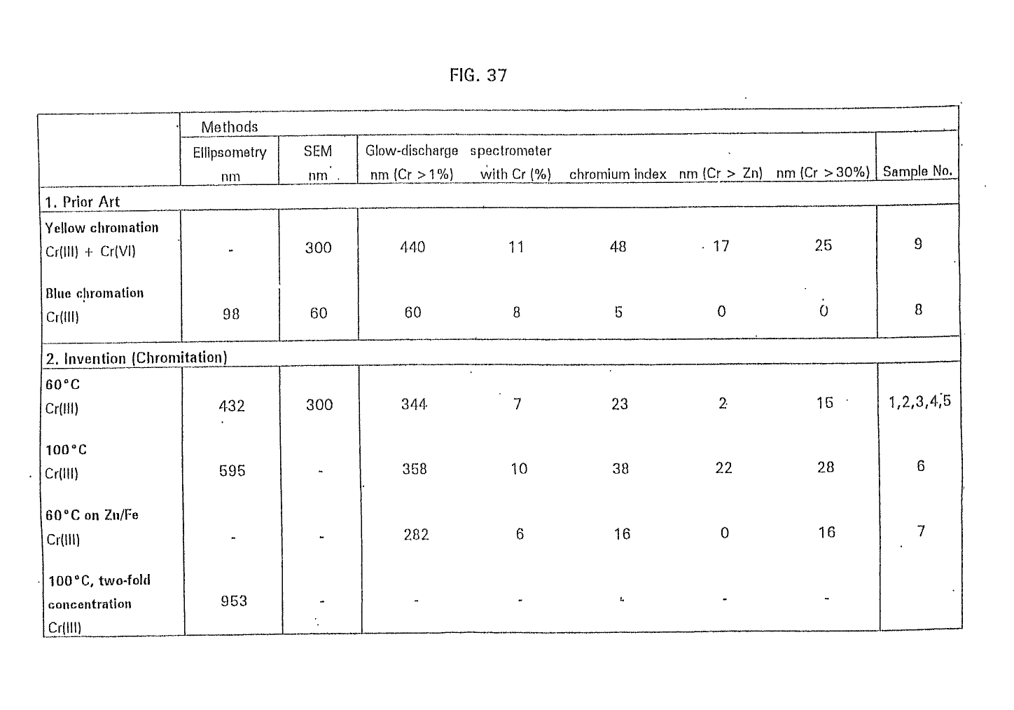

FIG. 37 is a table containing the evaluation of the depth profile analyses of FIGS. 5 to 36.

### EXAMPLE 1

The following experiment was carried out:

Small steel parts were bright-zinc coated electrolytically (approx. 15 μm) and, following galvanisation, singly immersed in a boiling (approx. 100° C.), aqueous solution containing:

100 g/l CrCl₃. 6 H₂O (trivalent chromium salt)

100 g/l NaNO₃

15.75 g/l NaF

26.5 g/l citric acid 1 aq

which had previously been adjusted to a pH value of 2.5 with sodium hydroxide solution. The immersion time was 30 s. The parts were then rinsed with water and dried in air flow. On the parts a greenish, strongly iridescent layer had formed which later on turned out to be comprised of zinc/chromium oxide. In the corrosion test in the salt spray cabinet according to DIN 50021 SS it was surprisingly found that the chromate layer formed presented a spectacular corrosion protection until the appearance of first corrosion products of 1000 h according to DIN 50961 Chapter 10, in particular Chapter 10.2.1.2.

The novel greenish chromate layer had a layer thickness of approx. 800 nm and was produced by a process not involving any chromium(VI) and could be proven to be chromium(VI)-free.

The production method according to Example 1 for the novel, greenish chromium(VI)-free chromation is not very economical for conventional plants due to the relatively high temperature of the process solution. Further theoretical reflections concerning chromium(VI)-free chromate coating and further trials finally resulted in economical production conditions.

### Theoretical Reflections Concerning Chromium(VI)-Free Chromation

Chromate coating of zinc takes place by the formation of a so-called conversion layer on the zinc surface, i.e. the zinc surface chemically reacts with the chromate coating solution and is converted into a chromate layer. The formation of conversion layers is a dynamic process beyond chemical equilibrium. In order to describe the underlying processes, one must therefore employ chemical kinetics. By the especially established kinetic model it was possible to obtain starting points in order to optimise the present invention.

Conversion layer formation in a chromium(III)-based chromate coating solution may be described by means of two reaction equations:

I Elementary zinc passes Into solution due to acid attack:

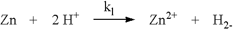

II and precipitates on the zinc surface as zinc chromium oxide together with chromium(III):

Zn²⁺+xCr^{(III)}+yH₂O→ZnCrₓO_{y}+2yH⁺

The kinetic model must encompass differential equations for the concentration developments of Zn², H⁺, Cr^{(III)} and for the thickness growth of the ZnCrO layer. In the reaction rate starting points it was taken into consideration by inserting the term 1/(1+P₁.m_{ZnCrO})² that Reaction I is increasingly slowed down by the growing passive layer. P1 is a measure for tightness of the layer.

$$\begin{matrix}{\frac{ⅆ {c}_{Zn} 2 +}{ⅆ t} = {k}_{1} \times {c}_{H} + / α + {p}_{1} \times {m}_{ZnCr0} )}^{2} - & Reaction I \\ {k}_{2} \times {c}_{Zn} 2 {+}_{Cr}^{xc} ( III ) + {k}_{3} \times {c}_{H} + x tanh ( {p}_{2} \times {m}_{ZnCr0} ) + & Reaction II \\ {k}_{T} \times ( {c}_{0 , Zn} 2 + - {c}_{Zn} 2 + ) & Mass transfer \\ {\frac{ⅆ {c}_{H} +}{ⅆ t} = - 2 {k}_{1} \times {c}_{H} + \text{/} α + {p}_{1} \times {m}_{ZnCr0} )}^{2} + & Reaction I \\ 2 {yk}_{2} \times {c}_{Zn} 2 {+}_{Cr}^{xc} ( III ) - 2 {yk}_{3} \times {c}_{H} + x tanh ( {p}_{2} \times {m}_{ZnCr0} ) + & Reaction II \\ {k}_{T} \times ( {c}_{0 , H } + - {c}_{H} + ) & Mass transfer \\ \frac{ⅆ {c}_{Cr} ( III )}{ⅆ t} = - {xk}_{2} \times {c}_{Zn} 2 {+}_{Cr}^{xc} ( III ) + {xk}_{3} \times {c}_{H} + x tanh ( {p}_{2} \times {m}_{ZnCr0} ) + & Reaction II \\ {k}_{T} \times ( {{c}_{0 , Cr } ( III )}_{Cr}^{- c} ( III ) ) & Mass transfer \\ \frac{ⅆ {m}_{ZnCr0}}{ⅆ t} = {k}_{2} \times {c}_{Zn} 2 {+}_{Cr}^{xc} ( III ) - {k}_{3} \times {c}_{H} + x tanh ( {p}_{2} \times {m}_{ZnCr0} ) & Reaction II\end{matrix}$$

The term tanh(P₂.m_{ZnCro} represents the indispensable precondition of reverse reaction II, namely the presence of ZnCrO. The tanh function provides for a smooth transition from 0 to 1, which may be adjusted with P2. The differential equation system was resolved numerically by means of a computer. As a result, the layer thickness developments and the concentration developments over time were obtained. As starting values for time t₀=0 there were employed:

| | |
|---|---|
| ^{C}0,Zn²⁺ = | 0 |
| ^{C}0,H⁺ = | 10⁻² mol/l (pH 2) |
| ^{C}0,Cr^{(III)} = | 0,5 mol/l |
| ^{m}0,ZnCrO = | 0 |

In FIG. 1 the layer thickness developments for various values of the rate constant kj are represented. For good corrosion protection, the passive layer should have maximum possible thickness and at the same time compactness.

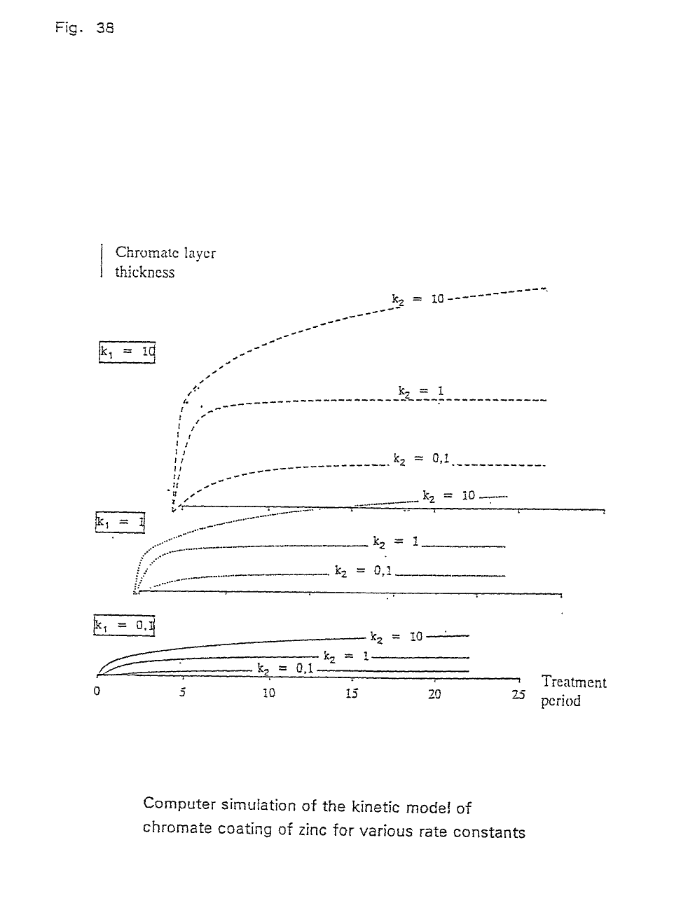

FIG. 38 (originally Illustration 1) shows a computer simulation of the kinetic model for chromate coating of zinc for various rate constants.

The faster the initial dissolution of zinc (rate constant k₁) is and the faster the dissolved zinc precipitates with the chromium(III) (rate constant k₂), the thicker the chromate layer will become. Layer growth is strongly favored by the presence of zinc already dissolved in the bath, which fact resulted from simulations with c_{0,Zn}2+>0. A lower pH value favors dissolution of zinc but also brings about increased redissolution of the layer.

Based on the model, basically two demands may be established for producing a maximum possible thickness chromate layer. Reaction I and forward reaction II must take place as rapidly as possible, the reverse reaction II must remain slow. In this sense, there result the following starting points:

Reaction I

a pH optimisation

b Avoiding carrying over of inhibitors from the zinc bath

c Addition of oxidants for accelerating zinc dissolution

d Acceleration of zinc dissolution by formation of galvanic elements

Forward reaction II

e The rate constant k₂ should be as high as possible. Chromium(III) complexes generally have slow kinetics. By using suitable ligands it should be possible to accelerate the reaction rate.

f Upon use of further transition metal cations in the chromate coating solution there also result i.a. higher rate constants than for Cr(III). Moreover these transition metal cations may act as catalysts in ligand replacement on chromium(III).

Reverse reaction II

g Insertion of poorly redissolvable hydroxides, e.g. nickel, cobalt and/or copper hydroxide.

Serial investigations were carried out. Starting points a and b are known to the skilled person. Acceleration of zinc dissolution via points c and d did also result in thick coatings, however yellowish ones having a chromium/zinc ratio of 1:4 to 1:3, which only afforded low corrosion protection. It was found that good corrosion protection values may only be obtained at chromium/zinc ratios above 1:2.

A higher chromium/zinc ratio at concurrently thicker chromate layers is obtained when the rate constant k₂ (starting point e) is raised, or the forward reaction II is accelerated. After the inventors of the present application had realised that hot chromium(III) solutions result in surprising passive layers, there are the following possibilities in connection with the inventors' theoretical reflections:

Raising the temperature of the chromate coating solution and/or of the partial surface

Raising the chromium(III) concentration in the process solution

Acceleration of ligand replacement kinetics at the chromium(III).

Herefor one should know that chromium(III) in aqueous solutions is essentially present in the form of hexagonal complexes generally having high kinetic stability, and moreover that ligand replacement is the step determining the rate in forward reaction III. By the selection of suitable complex ligands, with which the chromium(III) forms kinetically less stable complexes, k₂ is accordingly increased.

Addition of elements having a catalytic effect on ligand replacement into the chromate coating solution.

In serial investigations chelate ligands (such as di- and tricarboxylic acids as well as hydroxydi- and hydroxytricarboxylic acids) as such forming kinetically less stable complexes with chromium(III), whereas the fluoride complexes are kinetically very stable. When using only such chelate ligands for complexing the chromium(III) and omitting fluoride in the passivation solution, excellent results were obtained even at a treatment temperature of only 60° C., as is shown by Examples 2 and 3.

### EXAMPLE 2

Electrolytically bright-zinc coated (15 μm) steel parts were immersed in an aqueous chromate coating solution containing:

50 g/l CrCl₃. 6 H₂O (trivalent chromium salt)

100 g/l NaNO₃

31.2 g/l malonic acid

the pH of which had previously been adjusted to 2.0 with sodium hydroxide solution. The immersion time was 60 s. Following rinsing and drying there resulted in the salt spray cabinet according to DIN 50021 SS a corrosion protection of 250 h until first attack according to DIN 50961.

Malonic acid is a ligand enabling more rapid ligand replacement kinetics at the chromium(III) than the fluoride of Example 1. Good corrosion protection by far exceeding the minimum requirement of DIN 50961 for Method Group C (yellow chromation) may thus already be achieved at 60° C.

### EXAMPLE 3

Electrolytically bright-zinc coated (15 μm) steel parts were immersed in an aqueous chromate coating solution consisting of:

50 g/l CrCl₃. 6 H₂O (trivalent chromium salt)

3 g/l Co(NO₃)₂

100 g/l NaNO₃

31.2 g/l malonic acid

previously adjusted to pH 2.0 with sodium hydroxide solution. Immersion time was 60 s. Following rinsing and drying there resulted in the salt spray cabinet according to DIN 50021 SS a corrosion protection of 350 h until first attack according to DIN 50961.

Cobalt is an element which was capable, in accordance with the model concept, of catalysing ligand replacement and moreover reducing reverse reaction II owing to insertion of kinetically stable oxides into the chromate layer, so that the chromate layer altogether should become thicker. In this point, as well, the model concept established for the present invention is verified under practical conditions. Corrosion protection could once more clearly be enhanced in comparison with Example 3 by nothing but the addition of cobalt into the chromate coating solution.

Novel greenish chromate layers on zinc were produced in analogy with Example 2 at 40, 60, 80 and 100° C. The layer thicknesses of the respective chromate layers were determined by RBS (=Rutherford-Backscattering) testing. In the Table the corresponding corrosion protection values in hours of salt spray cabinet according to DIN 50021 SS until first attack according to DIN 50961 Chapter 10 are additionally listed.

| J/° C. | thickness/nm | Corr. Prot./h |
|---|---|---|
| 40 | 100 | 50-60 |
| 60 | 260 | 220-270 |
| 80 | 400 | 350-450 |
| 100 | 800 | 800-1200 |

Depending on the complex ligands used, which is malonate in Examples 2 and 3, it is partly possible to achieve even considerably higher layer thicknesses and corrosion protection values. By complex ligands containing as the complexing functional group nitrogen, phosphorus or sulfur, (—NR₂, —PR₂ wherein R independently is an organic, in particular aliphatic radical and/or H, and/or —SR, wherein R is an organic, in particular aliphatic radical or H,), it is possible to even produce the indicated layer properties within limits at room temperatures.

### EXAMPLE 4

Steel parts electrolytically coated with a zinc/iron alloy (0.4-0.6% iron) were immersed at 60° C. in the following aqueous chromate coating solution:

50 g/l CrCl₃. 6 H₂O

100 g/l NaNO₃

31.2 g/l malonic acid

The solution-was beforehand adjusted to pH 2.0 with NaOH. Immersion time was 60 s. Following rinsing and drying a transparent, greenish, slightly grey, strongly iridescent layer was visible on the zinc/iron. In the salt spray cabinet in accordance with the above specified DIN and ASTM standards there resulted a corrosion protection of 360 h until first attack according to DIN 50961.

### EXAMPLE 5

Steel parts electrolytically coated with a zinc/nickel alloy (8-13% nickel) were immersed at 60° C. into the following aqueous chromate coating solution:

50 g/l CrCl₃. 6 H₂O

100 g/l NaNO₃

31.2 g/l malonic acid

The solution was beforehand adjusted to pH 2.0 with NaOH. Immersion time was 60 s. Following rinsing and drying a transparent, greenish, dark-grey, strongly iridescent layer was visible on the zinc/nickel. In the salt spray cabinet in accordance with the above specified DIN and ASTM standards there resulted a corrosion protection of 504 h until first attack according to DIN 50961.

Further advantageous ligands result from the enumeration according to claims 9 and 11.

The novel greenish chromium(VI)-free chromate layer accordingly depending on the production temperature has a thickness of between 100 and 1000 nm, has a weakly green inherent color and a red-green iridescent coloring. The chromate coating solution consists of trivalent chromates, moreover of conducting salts and mineral acids. Application of the chromate coating solutions is generally performed at temperatures above 40° C. The corrosion protection of unmarred greenish chromium(VI)-free chromate coatings depending on the production temperature-amounts to 100-1200 h in the salt spray cabinet according to DIN 50021 SS until the first appearance of corrosion products. Thus the novel chromation satisfies the minimum requirements to corrosion protection for Method Groups C and D according to DIN 50961 (Chapter 10, Table 3), i.e. without chromium(VI) either in production or in the product.

By the present invention it is for the first time made possible to provide chromium(VI)-free conversion layers or passive layers on the basis of chromium(III), which do, however, furnish the corrosion protection of yellow chromations customary in the prior art—i.e., of chromium(VI)—containing passive layers.

This is a singular novelty in the entire galvanisation industry.

Hitherto on a chromium(III) basis only clear to blue layers, referred to as “blue passivation” in technical circles, were known which are variously applied practically.

Moreover yellowish-transparent layers with an addition of cerium are known which are, however, not used practically owing to the very costly cerium addition and their poor corrosion protection properties.

Moreover powdery-greenish layers are known for which the applicant—one of the leading enterprises in the field of surface technology—is not aware of any practical applications.

Even the difference in terms of color of the conversion layers of the present invention is conspicuous in FIG. 1, wherein three treatment methods were performed on zinc-plated screws.

The left-hand pile of screws in accordance with the illustration of FIG. 1 was subjected to a classical blue chromation—as set forth on page 2 of the description under No. 1.

The right-hand pile of screws on the photograph according to FIG. 1 was subjected to a conventional yellow chromation in accordance with page 2, No 2 of the present description.

The center pile of screws shows the result of passivation of the screws by means of the method in accordance with the invention.

This is consequently a greenish-iridescent, transparent conversion layer, or passive layer.

Moreover the colors represented in FIG. 1 are the true colors, which can be seen from the fact that a color plate and moreover a grey wedge was jointly photographed for the purpose of neutral color representation.

As can be seen from the white test field “White” and from the corresponding field having the density “0.00” from the grey wedge, both test fields are pure white, making evident the neutral filtering and the resulting realistic color representation.

In FIG. 2 scanning electron microscope (SEM) images of the conversion layers of a yellow chromation and of a blue chromation in accordance with the prior art are shown in comparison with the “chromitation” of the present invention.

The layer samples are derived from the correspondingly passivated zinc-plated iron screws shown in FIG. 2, lower half.

The samples treated in accordance with the invention (by “cromitation”) presented a chromium(VI)-free conversion layer having a thickness of approx. 300 nm. In the photographs of FIG. 2 it should be considered that the layers were photographed in a viewing angle of approx. 40°, resulting in foreshortening by approx. cos (40°)=0.77.

Based on the SEM images of the chromitation layer of the invention it therefore results that conversion layer thicknesses like in yellow chromation are obtained, however with the difference that the conversion layer of the invention does not contain any toxic chromium(VI).

The color photograph of FIG. 3 moreover shows the bandwidth of the iridescent coloring of the passive layer according to the invention under practical conditions.

It can already be seen in the photographs of FIGS. 1 and 3 that the passive layer according to the invention does not contain any chromium(VI) ions as it lacks the typically yellow color (cf. right-hand pile of screws of the color photograph of Enclosure 1).

Objects according to the photograph of FIGS. 1 and 3 as well as zinc-plated steel sheets passivated by the method of the invention were tested in the salt spray cabinet according to DIN50021SS or ASTM B 117-73, respectively, until the occurrence of first corrosion products according to DIN50961 Chapter 10. Herein it was surprisingly found that the passive layers of the present invention, and thus the objects passivated by the present method, fulfilled the corrosion protection of chromium(VI) passivations, i.e. yellow chromations, although not containing any chromium(VI).

It is worth mentioning that a typical yellow chromation of the prior art affords resistance for approx. 100 hours of exposure to saltwater in accordance with the above specified DIN or ASTN standard, whereas even the tenfold corrosion protection was achieved by the passive layers of the present invention.

The layers of the present invention as well as the methods for producing this layer, or the method for passivation of metal surfaces, thus satisfy the long-standing demand in this technical field for conversion layers doing without any toxic and carcinogenic chromium(VI) compounds while nevertheless even presenting and generally even excelling the corrosion protection of yellow chromations.

EP 00 34 040 A1 does describe a multitude of layers, wherein the colorations of the larger group thereof (produced under the standard conditions set forth by Barnes/Ward) are not specified, however which are referred to as clear. Two examples, i.e. Nos. 16 and 17, describe a greenish, borate-containing layer referred to as cloudy-dull to non-transparent.

Example 14 describes a layer affording a corrosion protection of no more than 4 hours.

In Example 15 of EP 00 34 040, an aluminum-containing layer is described which attains a corrosion protection of 100 hours. This is achieved—in comparison with the remaining examples—merely by the corrosion protection additive aluminum which is lacking in the present invention. Aluminum-free layers of identical or similar baths do, however, only present poor corrosion protection. The layer according to the invention offers significantly higher corrosion protection, namely up to 1000 h, even without this addition.

Examples 16 and 17 describe layers affording a corrosion protection of 300 and 200 hours in the salt spray test and thus in the range claimed by the applicant. Description page 19, line 7 sets forth that layers of more than 1000 nm are required for good corrosion protection. it is thus understandable that these layers, without exception moreover produced from solutions containing boric acid, are described to be cloudy and rather non-transparent (page 14, line 10). The enhanced corrosion protection, in accordance with page 15, lines 1-5, is due to the insertion of borate-containing species.

The layer according to the invention, on the other hand, also offers high (and even higher) corrosion protection without this addition. There is, however, another difference that is relevant in terms of patent law as well as in practical application: namely, the layers described in Examples 16 and 17 of EP 00 34 040 are soft and come off when wiped and consequently require some sort of hardening process as an aftertreatment (page 17, lines 12-21).

The present layers according to the invention are hard and resistant to wiping even without a hardening process. Corrosion protection layers which come off when wiped and which do not adhere to the substrate are useless for practical application.

In FIG. 4, a photograph is shown as a comparison example. This photograph represents the result of comparison tests carried out by the applicant in comparison with EP 00 34 040. In particular the applicant reproduced the Examples 16 and 17 given in this prior art. Herein steel sheets were immersed into the solutions described in Examples 16 and 17 of EP 00 34 040 and the respective treatment times were observed. FIG. 4 shows the layers on the substrate surfaces obtained in accordance with the prior art, namely from the top to the bottom the first and second sheets successively treated by immersion.

The photograph of FIG. 4 shows from the left to the right in the top half of the illustration a cloth whereby the layer produced in accordance with Example 16—prior art—was wiped, a zinc-plated steel sheet treated in accordance with Example 16, beside it a zinc-plated steel sheet treated in accordance with Example 17—prior art—and on the extreme right also a cloth whereby the layer of Example 17 was wiped. In the second line on the left side—beside the indication of Example 16 and beside it to the right ( beside the indication of Example 17) a respective zinc-plated steel sheet coated in accordance with the prior art is shown.

What is visible is a milky, white-greenish powdery coating which already comes off when wiped with a soft cloth even without application of particular pressure (see FIG. 4, top half of illustration). The prior art itself suggests that this layer is not a compact oxide zinc-/chromium conversion layer firmly adhering to the substrate sheet but a loosely overlying coating substantially consisting of chromium hydroxide. The pH for this coating must be so high that the precipitation limit for chromium hydroxides is already exceeded (page 26, line 12 of EP 0034 040). Precipitation of chromium hydroxide is kinetically inihibited and is favored by immersion of a more or less rough surface. The fact that the layer formation mechanism has to be a different one from the other examples may also be seen from the circumstance that with (Example 16 prior art) or without (Example 17) complexing agents more or less the same result was achieved. In practical reproduction of Examples 16 and 17 of the prior art it was moreover found that the layer became thicker, softer and more powdery with an increasing number of metal sheets coated in the solution. In addition, more and more chromium hydroxide precipitated, whereby the useful life of such a coating solution is limited to a few hours. The layer according to the invention, on the other hand, is produced only from suitable “rapid” complexes and furthermore in a distinctly acidic pH range. The solution is stable over months, presumably even years.

The measurements underlying FIGS. 5 to 36 were performed with a glow-discharge spectrometer.

The element F and die anions could not be analysed by this method. O, H, Cl and K could not be quantified.

The following Table shows the concentration ranges for which on is valid:

| Element | Concentration min. in | Concentration max. in |
|---|---|---|
| C | 0.0067 | 3.48 |
| S | 0.0055 | 0.168 |
| Cr | 0.0001 | 99.99 |
| Ni | 0.0001 | 99.99 |
| Co | 0.0001 | 7.00 |
| Zn | 0.0001 | 99.99 |
| Na | 0.0001 | 0.0068 |
| N | 0.0001 | 6.90 |
| B | 0.0001 | 0.040 |
| Fe | 0.0005 | 99.91 |

Sample allocation in FIGS. 5 to 36 results from the following Table:

| Sample | | | Measurement |
|---|---|---|---|
| No. | Coating | Conditions | point |
| 1 | Chromitation on | 60° C., 1 min, pH 2 | A |
| | Zn (invention) | | |
| | | | B |
| 2 | | 60° C., 2 min, pH 2 | A |
| | | | B |
| 3 | | 60° C., 1 min, pH 2.5 | A |
| 4 | | 60° C., 1.5 min, pH 2.5 | A |
| 5 | | 60° C., 2 min, pH 2.5 | A |
| 6 | | 100° C., 1 min, pH 2 | A |
| | | | B |
| | | | C |
| | | | D |
| 7 | Chromitation on | 60° C., 1 min, pH 2 | A |
| | Zn/Fe | | |
| | | | B |
| 8 | Blue chromation | 20° C., 30 s, pH 1.8 | A |
| | on Zn | | |
| 9 | Yellow chromation | 20° C., 45 s, pH 1.8 | A |
| | on Zn | | |
| | | | B |

FIG. 37 shows a Table containing the evaluations of the depth profile measurements, which indicates that all of the (chromitation) layers of the invention have thicknesses exceeding 100 nm.

1. A chromium(VI)-free, chromium(III)-containing and substantially coherent conversion layer on zinc or zinc alloys, characterised in that
even in the absence of further components such as silicate, cerium, aluminum and borate it presents a corrosion protection of approx. 100 to 1000 h in the salt spray test according to DIN 50021 SS or ASTM B 117-73 until first attack according to DIN 50961 Chapter 10;
it is clear, transparent and essentially colorless and presents multi-colored iridescence;
it has a layer thickness of approx. 100 nm to 1000 nm; and
it is hard. adheres well and is resistant to wiping.

2. A conversion layer according to claim 1, characterised in that
it has across the conversion layer thickness a chromium content of up to approx. 1%, in relation to zinc and chromium in the conversion layer an average chromium content of more than approx. 5%,
it has a chromium-rich zone>approx. 20% chromium, in relation to zinc and chromium in the conversion layer, of more than approx. 15 nm; and
it has a chromium index>approx. 10.

3. A conversion layer according to claim 1 or 2, characterised in that it may contain, for further enhanced corrosion protection, additional components selected from the group consisting of: silicate, cerium, aluminum and borate;
additional metal compounds, in particular 1- to 6-valent metal compounds, for example compounds of Na, Ag, Al, Co, Ni, Fe, Ga, In, lanthanides, Zr; Sc, Ti, V, Cr, Mn, Cu, Zn, Y, Nb, Mo, Hf, Ta, W; and
anions, in particular halide ions, in particular chloride ions; sulfurous ions, in particular sulfate ions, nitrate ions; phosphoric ions, in particular phosphate ions, diphosphate ions, linear and/or cyclic oligophosphate ions, linear and/or cyclic polyphosphate ions, hydrogen phosphate ions; carboxylic acid anions; and silicon-containing anions, in particular silicate anions; and
polymers, in particular organic polymers, corrosion inhibitors; silicic acids, in particular colloidal or disperse silicic acids; surfactants; diols, triols, polyols; organic acids, in particular monocarboxylic acids; amines; plastics dispersions; dyes, pigments, in particular carbon black, chromogenic agents, in particular metallic chromogenic agents; amino acids, in particular glycin; siccatives, in particular cobalt siccatives; dispersing agents; and
mixtures thereof.

4. A conversion layer according to any one of claims 1 to 3, characterised in that it is a basis for further inorganic and/or organic layers.

5. A conversion layer according to any one of claims 1 to 4, characterised in that it contains dyes or color pigments for modification of the inherent color thereof.

6. A conversion layer according to any one of claims 1 to 5, characterised in that its layer thickness is approx. 100 nm.

7. A method for producing chromium(VI)-free conversion layers affording at least the corrosion protection of conventional chromium(VI)-containing yellow chromations, wherein
a metallic surface, in particular one of zinc or zinc alloys, in particular with iron, is treated with a solution of at least one chromium(III) complex and at least one salt characterised in that
the concentration of the chromium(III) complex is increased in comparison with a conventional trivalent blue chromation; and/or
a chromium(III) complex is used having ligand replacement kinetics more rapid than the fluoride replacement kinetics in chromium(III)-fluorocomplexes.

8. A method according to claim 7, characterised in that treatment is carried out at an elevated temperature, in particular 20 to 100° C., preferably 20 to 80° C., in a preferred manner 30 to 60° C., in a particularly preferred manner 40 to 60° C.

9. A method according to any one of claims 7 or 8, characterised in that the ligands of the chromium(III) complex are selected from the group consisting of:
chelate ligands, such as dicarboxylic acids, tricarboxylic acids, hydroxycarboxylic acids, in particular oxalic, malonic, succinic, glutaric, adipic, pimelic, suberic, azelaic, sebacic acid; and
furthermore, maleic acid, phthalic acid, terephthalic acid, tartaric acid, citric acid, malic acid, ascorbic acid; and further chelate ligands such as acetylacetone, urea, urea derivatives, and
further complex ligands wherein the complexing functional group contains nitrogen, phosphorus or sulfur (—NR₂, —PR₂ wherein R independently is an organic, in particular aliphatic radical and/or H, and/or —SR, wherein R is an organic, in particular aliphatic radical or H); phosphinates and phosphinate derivatives; as well as
suitable mixtures thereof, among each other as well as in mixed complexes with inorganic anions and H₂O and/or
the method is performed repeatedly on the surface to be passivated.

10. A concentrate for producing a passivation solution for surfaces of zinc or zinc alloys, in particular ones with iron, wherein it substantially contains chromium(III) for a passivating component, characterised in that
the chromium(III) is present in the form of at least one complex having ligand replacement kinetics more rapid than the fluoride replacement kinetics in chromium(III)-fluorocomplexes.

11. A concentrate according to claim 10, characterised in that the chromium(III) complex is selected from complexes with chromium(III) and at least one ligand from the group consisting of:
chelate ligands, such as dicarboxylic acids, tricarboxylic acids, hydroxycarboxylic acids, in particular oxalic, malonic, succinic, glutaric, adipic, pimelic, suberic, azelaic, sebacic acid: and
furthermore, maleic acid, phthalic acid, terephthalic acid. tartaric acid, citric acid, malic acid, ascorbic acid; and
further chelate ligands such as acetylacetone, urea, urea derivaties, and
further complex ligands wherein the complexing functional group contains nitrogen, phosphorus or sulfur (—NR₂, —PR₂, wherein R independently is an organic, in particular aliphatic radical and/or H, and/or —SR, wherein R is an organic, in particular aliphatic radical or H,); phosphinates and phosphinate derivatives; as well as suitable mixtures thereof, among each other as well as in mixed complexes with inorganic anions and H₂O.

12. A concentrate according to any one of claims 10 or 11, characterised in that the concentrate is present in solid or liquid form

13. A concentrate according to any one of claims 10 to 12, characterised in that it contains further additives selected from the group consisting of: sealers, dewatering fluids; and
additional metal compounds, in particular 1- to 6-valent metal compounds, for example compounds of Na, Ag, Al, Co, Ni, Fe, Ga, In, lanthanides, Zr; Sc, Ti, V, Cr, Mn, Cu, Zn, Y, Nb, Mo, Hf, Ta, W; and
anions, in particular halide ions, in particular chloride ions; sulfurous ions, in particular sulfate ions, nitrate ions; phosphoric ions, in particular phosphate ions, diphosphate ions, linear and/or cyclic oligophosphate ions, linear and/or cyclic polyphosphate ions, hydrogen phosphate ions; carboxylic acid anions; and silicon-containing anions, in particular silicate anions; and
polymers, in particular organic polymers, corrosion inhibitors: silicic acids. in particular colloidal or disperse silicic acids: surfactants; diols, triols, polyols; organic acids, in particular monocarboxylic acids; amines; plastics dispersions; dyes, pigments, in particular carbon black, chromogenic agents, in particular metallic chromogenic agents; amino acids, in particular glycin; siccatives, in particular cobalt siccatives: dispersing agents; as well as
mixtures thereof.

14. A passivation bath for passivating metal surfaces, in particular ones of zinc, cadmium or aluminum, or alloys of these metals among each other and/or with other metals, in particular with iron, characterised in that
it substantially contains chromium(III) as a passivating component, wherein chromium(III) is present in a concentration of approx. 5 to 100 g/l.

15. A passivation bath according to claim 14, characterised in that chromium(III) is present in a concentration of approx. 5 g/l to 80 g/l, in particular of approx. 5 g/l to 60 g/l, in a particularly preferred manner of approx. 10 g/l to 30 g/l, preferably approx. 20 g/l.

16. A passivation bath according to claim 14 or 15, characterised in that it has a pH between approx. 1.5 and 3.

17. A passivation bath according to any one of claims 14 to 16, characterised in that it contains approx. 20 g/l chromium(ill) and has a pH of approx. 2 to 2.5.

18. A passivation bath according to any one of claims 14 to 17, characterised in that it contains further additives in particular selected from the group consisting of sealers, dewatering fluids: and
additional metal compounds, in particular 1- to 6-valent metal compounds, for example compounds of Na, Ag, Al, Co, Ni, re, Ga, In, lanthanides, Zr; Sc, Ti, V, Cr, Mn, Cu, Zn, Y, Nb, Mo, Hf, Ta, W; and
anions, in particular halide ions, in particular chloride ions; sulfurous ions, in particular sulfate ions, nitrate ions; phosphoric ions, in particular phosphate ions, diphosphate ions, linear and/or cyclic oligophosphate ions, linear and/or cyclic polyphosphate ions, hydrogen phosphate ions; carboxylic acid anions; and silicon-containing anions, in particular silicate anions: and
polymers, corrosion inhibitors; silicic acids, in particular colloidal or disperse silicic acids; surfactants; diols, triols, polyols; organic acids, in particular monocarboxylic acids; amines; plastics dispersions; dyes, pigments, in particular carbon black, chromogenic agents, in particular metallic chromogenic agents; amino acids, in particular glycin; siccatives, in particular cobalt siccative; dispersing agents; as well as
mixtures thereof.

19. A passivation bath according to any one of claims 14 to 18, characterised in that it has a bath temperature of approx. 20 to 100° C., preferably 20 to 80° C., in a preferred manner 30 to 60° C., in a particularly preferred manner 40 to 60° C.

20. A method for passivating surfaces of zinc or zinc alloys, in particular ones with iron, characterised in that
the objects to be treated are immersed in a passivation bath according to any one of claims 14 to 19.

21. A method according to claim 20, characterised in that the immersion period is between approx. 15 and 200 seconds, in particular between approx. 15 and 100 seconds, preferably approx. 30 seconds.

22. A method according to any one of claims 20 or 21, characterised in that it is an elevated-temperature chromate coating method with rinsing water recycling over at least 2 cascaded rinsing stages

23. A method according to claim 22, characterised in that a blue chromation is performed in one of the rinsing steps.

24. A passive layer obtainable by a method according to at least one of claims 20 to 23.

25. A passive layer according to claim 24, characterised in that it imparts a corrosion protection to an object such as to present a corrosion protection of at least 100 hours in the salt spray test according to DIN 50021 SS until first attack according to DIN 50961 Chapter 10.

26. A passive layer according to claim 24 or 25, characterised in that it presents a greenish, red-green iridescent color for zinc.

27. A passive layer according to any one of claims 24 to 26, characterised in that its layer thickness is approx. 100 nm.

28. A conversion layer obtainable by a method according to at least one of claims 7 to 9.
